(19) United States
(12) Patent Application Publication
(10) Pub. No.: US 2003/0144045 A1
(43) Pub. Date: Jul. 31, 2003

(54) Method, apparatus, storage medium, data signal and program for generating image of virtual space

(75) Inventor: Mitsumasa Fujita, Kawasaki-shi (JP)

Correspondence Address: OLIFF & BERRIDGE, PLC, P.O. BOX 19928, ALEXANDRIA, VA, 22320, US

(73) Assignee: Namco Ltd., Tokyo (JP)

(21) Appl. No.: 10/340,630

(22) Filed: Jan. 13, 2003

(30) Foreign Application Priority Data
Jan. 25, 2002 (JP) PATENT 2002-17273

(51) Int. Cl. G06F 19/00; G06F 17/00; A63F 13/00; A63F 9/24

(52) U.S. Cl. 463/1

(57) ABSTRACT

A method for expressing a psychological change of a character according to a positional relation, in a ball game realized by a game apparatus. The method for moving a predetermined character according to an inputted operation, executing a ball game in which a plurality of characters including the predetermined character appear, and generating an image of a virtual space in which the plurality of characters are provided, on the basis of a view point, has: determining whether a positional relation between a ball possessing character which possesses a ball and a second character, of the plurality of characters, satisfies a positional condition, or not; and changing a movement ability of at least one of the ball possessing character and the second character, when the positional relation satisfies the positional condition.

### BACKGROUND OF THE INVENTION

1. Field of the Invention

The invention relates to a method, an apparatus, a storage medium, a data signal and a program for replaying an operation inputted by a user and executing a game in a virtual space, and further generating an image of the virtual space at a real time.

2. Description of Related Art

Conventionally, many types of game apparatuses have been developed, the game apparatuses replaying an inputted operation and executing a game, and further generating a game image at a real time and displaying the game image on a display. For example, a type of game apparatus capable of realizing a game by connecting a display such as a television or the like, and a game controller for inputting an operation to the game apparatus body, a small size of game apparatus comprising a display screen and a controller in a body, or the like, has been developed as a consumer game machine. Further, a game apparatus comprising a covering body having a large size display and an operating panel in a body, has been developed as an arcade game machine. Further, many games have been developed, the games capable of being realized by a personal computer (PC) or the like through a network. Many of the game apparatuses or the games control a movement of a character on the basis of the inputted operation, a program, data or the like, generate an image of a virtual space including the character on the basis of a virtual camera (a view point), and display the image.

There are various types of games realized by the above-described types of game apparatuses. One of the games is a basket ball game. According to the basket ball game, one team consists of five characters, and two teams, that is, ten characters fight with each other on a game court determined in the virtual space. A player operates a character of one of the two teams with the game controller. For example, in case a character as an object operated by the player possesses a ball, the player specifies a direction in which the character dribbles the ball with a direction key, or specifies if the character passes the ball or not, or if the character shoots the ball, with a function key. On the other hand, in case the character as the object operated by the player does not possess the ball, the player specifies the direction in which the character moves with the direction key, or specifies the movement of the character to obstruct a movement of a character of an opponent team, to take back the ball or the like, with the function key.

Further, some of the games in which a plurality of characters appear on the screen at the same time, such as the above-described basket ball game, are determined so as to provide a proper ability for each character, distinguish the characters from each other, and be developed more complicatedly and realistically. For example, some games can make the difference in the movement ability of each character, for the shot, the pass, the dribble, the jump or the like, clear, and express the individual character of each character. Therefore, the player playing the game uses the movement ability of each character properly, and works out the plan of game operations.

As described above, there have been a plurality of games which makes the character display the proper movement ability, not only the basket ball game, in the past. However, it has been rare for the ball game capable of replying the inputted operation and realizing the game at a real time, to express the movement of the mind of the character and reflect the mind on the game realistically, while executing the game. Regarding the real basket ball game, when a player contacts with another player bodily, there is a case the player is affected psychologically, and a change in the play of the player appears. For example, when the player is marked by an undesirable opponent player, there is a case the player feels the pressure from the opponent player, and cannot display the ability sufficiently. Therefore, there is a case the psychological effect is adopted in the plan of the real ball game. However, there has been not game apparatuses which execute games capable of adopting the psychological plans.

### SUMMARY OF THE INVENTION

The present invention was developed in view of the above-described problems.

It is an object of the present invention to express a psychological change of a character according to a positional relation, in a ball game realized by a game apparatus.

In accordance with a first aspect of the present invention, a method for moving a predetermined character according to an inputted operation, executing a ball game in which a plurality of characters including the predetermined character appear, and generating an image of a virtual space in which the plurality of characters are provided, on the basis of a view point, comprises: determining whether a positional relation between a ball possessing character which possesses a ball and a second character, of the plurality of characters, satisfies a positional condition, or not; and changing a movement ability of at least one of the ball possessing character and the second character, when the positional relation satisfies the positional condition.

In accordance with a second aspect of the present invention, an apparatus for moving a predetermined character according to an inputted operation, generating and displaying an image of a virtual space in which a plurality of characters including the predetermined character are provided, on the basis of a view point, and executing a ball game in which the plurality of characters appear, comprises: a position determining section for determining whether a positional relation between a ball possessing character which possesses a ball and a second character, of the plurality of characters, satisfies a positional condition, or not; and a movement ability changing section for changing a movement ability of at least one of the ball possessing character and the second character, when the positional relation satisfies the positional condition.

According to the method of the first aspect or the apparatus of the second aspect of the present invention, the positional relation between the ball possessing character and the second character is determined. When there is any character having the positional relation which satisfies the positional condition, the movement ability of the ball possessing character or the character having the positional relation which satisfies the positional condition, can be changed. That is, it is possible to change the movement ability of the character according to the positional relation between the characters. Consequently, for example, in a game such as a basket ball game in which it is possible a bodily contact occurs between characters, it is possible to express the psychological change of the player character, caused by the positional relation, by changing the movement ability of the player character. Further, because the movement ability is changed according to the positional relation, it is possible to develop the game more complicatedly and realistically.

Preferably, in the method of the first aspect of the present invention, the positional condition includes whether the second character is in a predetermined direction of the ball possessing character, or not.

According to the method, it is possible to determine whether the movement ability is changed or not, according to the direction of the second character to the ball possessing character. Consequently, like in case the second character is in one direction from the ball possessing character, the movement ability is not changed, and in case the second character is in another direction other than the one direction, the movement ability is changed, it is possible to produce the peculiarity of the direction. As a result, for example, it is possible that the movement ability is not changed when the second character is behind the ball possessing character, and the ability is changed when the second character is in the direction other than the back of the ball possessing character.

Preferably, in the method of the first aspect of the present invention, the positional condition includes whether the second character is within a predetermined range following the ball possessing character, or not.

According to the method, it is determined whether the second character is within the predetermined range following the ball possessing character or not, as the positional condition. In order to determine it, the case the second character is within the predetermined range, may mean that the positional relation satisfies the positional condition. Further, the case the second character is beyond the predetermined range, may mean that the positional relation satisfies the positional condition. Consequently, it is possible to determine the position easily, by determining whether the second character is within or beyond the predetermined range. Further, because the predetermined range follows the ball possessing character, for example, when the predetermined range is determined so as to be always located near the position of the ball possessing character, it is possible to determine whether the second character is far from or near to the ball possessing character.

Preferably, in the method as described above, the changing a movement ability includes determining a quantity of change in a movement ability of at least one of the ball possessing character and other characters which are within the predetermined range, according to a number of the other characters.

Preferably, in the method as described above, the changing a movement ability includes determining a quantity of change in the movement ability, according to a time the second character is within the predetermined range.

According to the method, the movement ability is changed according to the number of other characters each of which has the positional relation which satisfies the positional condition, or the time the second character is within the predetermined range. Consequently, for example, it is possible that the movement ability is determined so as to be changed more, as the number of characters having the positional relations each of which satisfies the positional condition, increases or decreases. As a result, it is possible to produce the mind of the ball possessing character, like a more psychological burden is borne, and the movement ability falls, as the number of defenses increases. Further, it is possible that the movement ability is determined so as to fall or improve more, or so as to get back to usually, as the positional relation satisfies the positional condition for a longer time.

Preferably, in the method of the first aspect of the present invention, the changing a movement ability includes determining a quantity of change in the movement ability according to a distance between the ball possessing character and the second character.

According to the method, the movement ability is changed according to the distance between the second character having the positional relation which satisfies the positional condition and the ball possessing character. Consequently, for example, it is possible that the movement ability is determined so as to be changed more, as the second character goes nearer to or farther away from the ball possessing character. As a result, for example, it is possible to express the psychological change caused by the defense character which approaches the ball possessing character, by changing the movement ability.

Preferably, in the method of the first aspect of the present invention, the changing a movement ability includes changing a movement ability of the ball possessing character.

According to the method, when the positional relation satisfies the positional condition, the movement ability of the ball possessing character is changed. Consequently, for example, it is possible to clear the movement of the character for the defense. In a conventional basket ball game or the like, the physical contact of the defense with the offense hinders the offense from moving. However, according to the present invention, it is possible to drop the movement ability of the ball possessing character according to the positional relation between the ball possessing character and the second character.

Preferably, in the method as described above, the changing the movement ability includes determining a quantity of change in the movement ability, according as which character of the plurality of characters which appear in the ball game is the second character.

According to the method, the quantity of change in the movement ability of the ball possessing character is determined according to a type of the second character. For example, it is possible to determine the quantity of change in the movement ability so that the quantity of change in case the second character “A” approaches the ball possessing character, differs from the quantity of change in case the second character “B” approaches the ball possessing character. Consequently, it is possible to express whether each character is good at the defense or not, as the individual character of each character.

Preferably, in the method as described above, the changing the movement ability includes determining a quantity of change in the movement ability, according as which character of the plurality of characters which appear in the ball game is the ball possessing character.

According to the method, the quantity of change in the movement ability is determined according to a type of the ball possessing character. For example, it is possible to determine the quantity of change in the movement ability so that the quantity of change in case a character “A” possess a ball, differs from the quantity of change in case a character “B” possess a ball, when the positional relation satisfies the positional condition. Consequently, it is possible to express a character a mind of which is disturbed easily, a character a mind of which is hardly disturbed, or the like, according to the positional relation between the characters.

Preferably, in the method as described above, the changing the movement ability includes determining a quantity of change in the movement ability, according as what combination of characters of the plurality of characters which appear in the ball game is a combination of the ball possessing character and the second character.

According to the method, the quantity of change in the movement ability is changed according to the combination of the ball possessing character and the second character having the positional relation which satisfies the positional condition. For example, it is possible to produce the difference, like a movement ability of a ball possessing character “A” can be changed more largely in a case a character “B” approaches the ball possessing character “A”, than a case a character “C” approaches the ball possessing character “A”, and a movement ability of a ball possessing character “D” can be changed more largely in a case the character “C” approaches the ball possessing character “D”, than a case the character “B” approaches the ball possessing character “D”.

Preferably, in the method as described above, the changing the movement ability includes determining a quantity of change in the movement ability, according to a combination of a position of the ball possessing character and a position of the second character.

According to the method, the quantity of change in the movement ability is determined according to the position of the ball possessing character and the position of the second character having the positional relation which satisfies the positional condition. Consequently, it is possible to produce, like, for example, in case characters in non-correlative positions approach each other, the quantity of change in the movement ability is small, and in case characters in close correlative positions approach each other, the quantity of change in the movement ability is large.

Preferably, in the method as described above, the changing the movement ability includes changing the movement ability only when the second character belongs to an opponent team of the ball possessing character, in the ball game.

According to the method, the movement ability of the ball possessing character is changed when a character belonging to the opponent team of the ball possessing character has the positional relation which satisfies the positional condition. On the other words, the movement ability of the ball possessing character is changed when a character belonging to an ally team of the ball possessing character has the positional relation which satisfies the positional condition. Consequently, it is possible to clearly distinguish the movement of the character at the offence from the movement of the character at the defense.

The movement ability of the ball possessing character includes various types of movement abilities. For example, preferably, the changing the movement ability includes changing the movement ability for at least one of a shot, a pass, a jump and a dribble, of the ball possessing character.

Preferably, the method of the first aspect of the present invention, further comprises: making the ball possessing character look over a circumference of the ball possessing character, wherein the determining whether a positional relation between a ball possessing character which possesses a ball and a second character, of the plurality of characters, satisfies a positional condition, or not, includes determining whether the positional relation satisfies the positional condition or not, when the ball possessing character looks over the circumference.

According to the method, the ball possessing character looks over the circumference in the virtual space. Further, it is determined whether the positional relation satisfies the positional condition or not, when the ball possessing character looks over the circumference. On the other word, the movement of the ball possessing character which looks over causes the determination whether the positional relation satisfies the positional condition or not. For example, in the basket ball game or the like, there is a case the character looks over the circumference and determines the target to which the character passes the ball. In the game, it is possible to determine whether to change the movement ability or not, or to determine the quantity of change in the movement ability, on the basis of the positional condition when the character looks over the circumference.

Preferably, in the method of the first aspect of the present invention, the changing a movement ability includes determining a quantity of change in the movement ability according to any one of a rest time and a score difference of the ball game.

According to the method, it is possible to determine the quantity of change in the movement ability according to the rest time or the score difference of the game. Consequently, it is possible to express both the psychological effect based on the positional relation between the characters, and the psychological effect based on the progress state of the game such as the time, the score difference or the like, by changing the movement ability.

Preferably, the method of the first aspect of the present invention, further comprises: changing an expression of the ball possessing character, when the positional relation satisfies the positional condition.

Herein, the expression includes a look, a complexion, a sweat, a motion and so on.

According to the method, it is possible to change the expression of the ball possessing character when the positional relation satisfies the positional condition. For example, it is possible to express the state wherein the ball possessing character has a pale complexion, a sweat stand on a forehead or near a head of the ball possessing character, the ball possessing character is scared, or the like. Consequently, it is possible to express the impatience or the disturbance of the ball possessing character, visually, and to inform the player of the change in the movement ability of the ball possessing character, indirectly.

Preferably, the method of the first aspect of the present invention, further comprises: changing a range to be displayed, of the image of the virtual space on the basis of the view point.

According to the method, the range to be displayed, on the image of the virtual space is changed, when the positional relation satisfies the positional condition. It is possible to change the range to be displayed, of the image, like, for example, the whole court in the ball game is displayed when the positional relation does not satisfy the positional condition, and the image is displayed so as to direct attention to the character having the positional relation when the positional relation satisfies the positional condition. Consequently, it is possible to subjectively express the mind of the character when the positional relation satisfies the positional condition, by changing not only the movement ability, but also the display state.

Preferably, in the method as described above, the changing a range includes determining a quantity of change in the range to be displayed, on the basis of at least one of a distance between the ball possessing character and the second character, a number of other characters each of which has the positional relation which satisfies the positional condition, and a passage time the positional relation satisfies the positional condition.

According to the method, the range of the image to be displayed, is changed according to the distance between the ball possessing character and the second character having the positional relation which satisfies the positional condition, the number of characters each of which has the positional relation which satisfies the positional condition, or the passage time. Consequently, for example, it is possible to subjectively express the disturbance or the strain of the ball possessing character, caused by that the defense approaches the ball possessing character, or the number of defenses increases, by changing the display state.

A plurality of methods are given as the method for changing the range of the image to be displayed.

For example, in the method as described above, the changing a range includes changing the range to be displayed, by performing at least one of a processing for changing a distance of the view point to the ball possessing character, a processing for changing a view angle of the view point, and a processing for shading a circumference of the ball possessing character.

In accordance with a third aspect of the present invention, a method comprises: determining whether a positional relation between at least two characters of a plurality of characters which appear in a game, satisfies a positional condition, or not; and changing a movement ability of at least one of the at least two characters, when the positional relation satisfies the positional condition.

In accordance with a fourth aspect of the present invention, a storage medium has information recorded thereon, when the information is loaded onto an operating apparatus, the information making the operating apparatus execute any one of the above-described methods.

In accordance with a fifth aspect of the present invention, a data signal embodied in a carrier wave, comprises information used for executing any one of the above-described methods.

In accordance with a sixth aspect of the present invention, a program, when the program is loaded onto an operating apparatus, makes the operating apparatus execute any one of the above-described methods.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a view showing an external appearance of a game apparatus according to an embodiment of the present invention;

FIG. 2 is a view showing an example of a game image according to the embodiment of the present invention;

FIG. 3 is a view showing an example of a game image when a positional condition is not satisfied;

FIG. 4 is a view showing an example of a game image when the positional condition is satisfied;

FIG. 5 is a view showing an example of a game image when the positional condition is not satisfied;

FIG. 6 is a view showing an example of a game image when a displayed range of the game image is changed;

FIG. 7 is a block diagram showing a functional block of the game apparatus according to the embodiment of the present invention;

FIG. 8A is a plan view of a virtual space, and FIG. 8B is a view showing an example of a determined range;

FIG. 9 is a flow chart for explaining a position determination processing;

FIG. 10 is a table showing an example of attribute data 520;

FIG. 11 is a table showing an example of a relative table;

FIG. 12 is a plan view of a court in the virtual space;

FIGS. 13A and 13B are flow charts for explaining a movement control processing;

FIG. 14 is a plan view of the court in the virtual space;

FIG. 15 is a view for explaining a positional relation between an operated character and a view point;

FIG. 16A is a view showing a usual positional relation between the operated character and the view point, FIG. 16B is a view showing an example when a depression “τ_{O}” is constant, and FIG. 16C is a view showing an example when the depression angle “τ_{O}” is changed;

FIG. 17 is a flow chart for explaining a view point control processing;

FIG. 18 is a block diagram showing a hardware structure of the game apparatus 1 according to the embodiment of the present invention;

FIG. 19 is a view showing an example of a game system comprising a host apparatus and terminals, to which the present invention is applied;

FIG. 20 is a view showing an example of an arcade game machine to which the present invention is applied;

FIG. 21 is a table showing an example of a correlative table;

FIGS. 22A is a view showing a usual relation between the view point and a view angle, and FIG. 22B is a view showing a relation between the view point and the view angle when the positional condition is satisfied;

FIG. 23 is a view showing an example of a usual game image; and

FIG. 24 is a view showing an example of the game image when the view angle is reduced.

### PREFERRED EMBODIMENTS OF THE INVENTION

Hereinafter, a preferred embodiment of the present invention will be explained with reference to figures.

Hereinafter, although the present invention will be explained in case a consumer game machine executes a basket ball game, as an example, it should be understood that the present invention is not limited to the case.

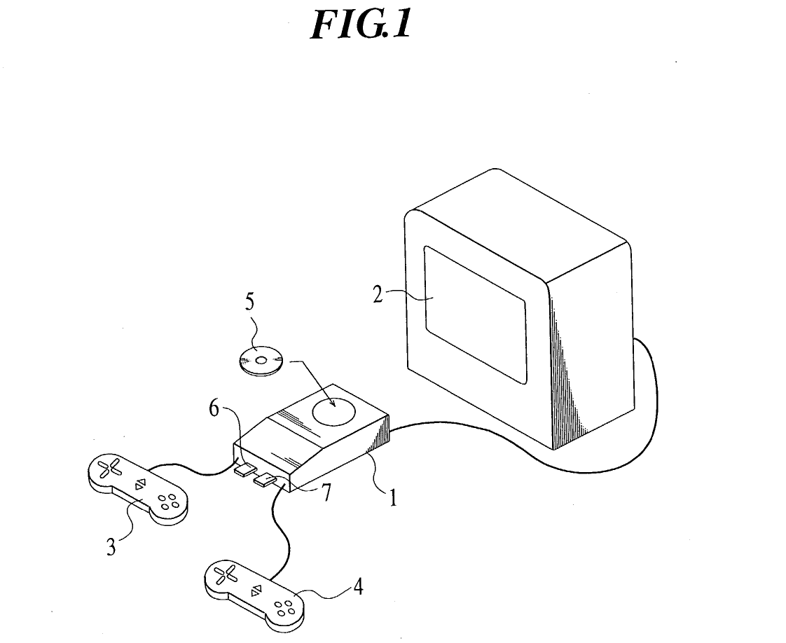

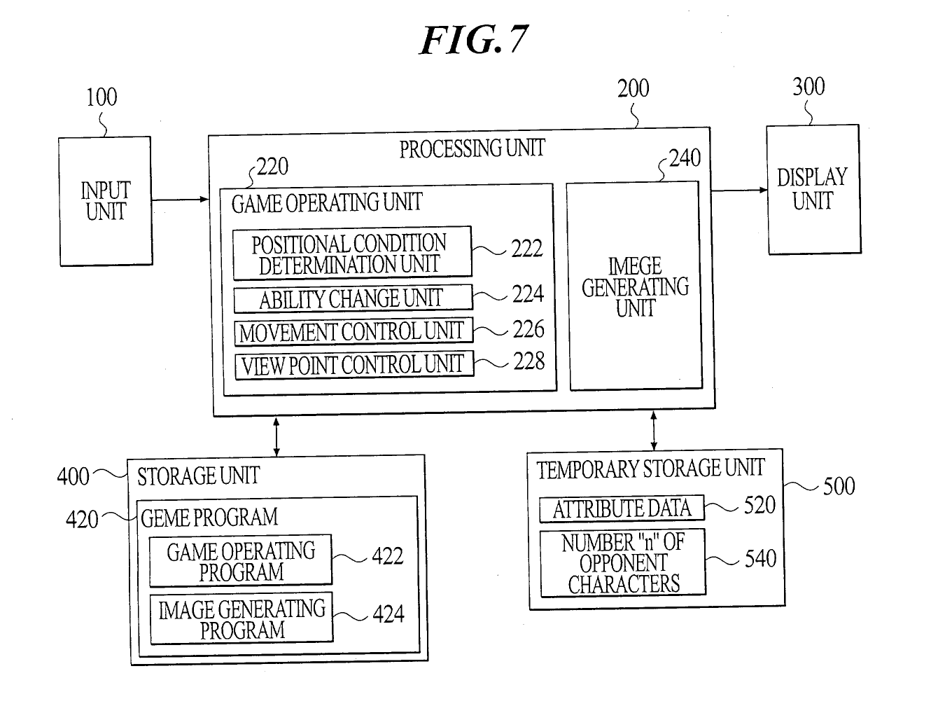

FIG. 1 is a view showing an example of a consumer game apparatus 1. As shown in FIG. 1, the game apparatus 1 has a structure that a display 2, game controllers 3 and 4 or the like can be attached to and detached from the game apparatus 1. A processing system of the game apparatus 1 generates an image on the basis of data such as a system program, a game program 420 (shown in FIG. 7) or the like, and a signal inputted from the game controllers 3 or 4, and displays the image on the display 2. The system program, the game program 420, game data, necessary information to realize the present embodiment, or the like, is stored in a CD-ROM 5, an IC card 6 or a memory card 7 as a storage medium which can be attached to and detached from the game apparatus 1, a data storage medium provided for the game apparatus 1, or the like.

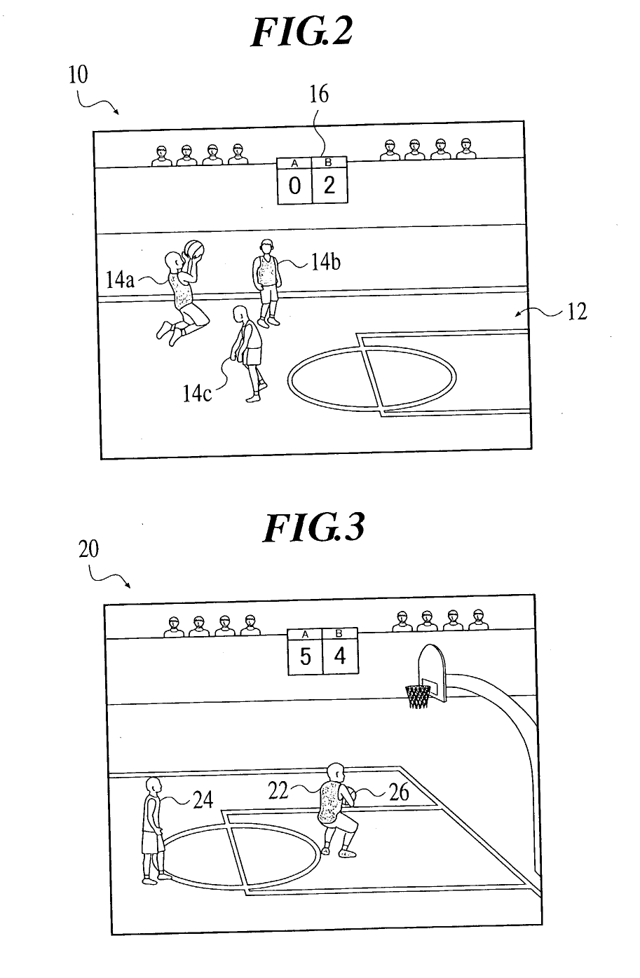

FIG. 2 is a view showing an example of a game image 10 of the basket ball game according to the present embodiment. As shown in FIG. 2, a basket ball court 12, a plurality of player characters 14a, 14b, 14c and so on, and a score 16 are displayed on the game image 10. Each player character belongs to any team of a team A and a team B. A color or design of a uniform of each player character shows the team to which the player character belongs, distinctly.

The player enjoys playing the basket ball game by operating the game controller 3 or 4, with watching the game image displayed on the display 2. Herein, according to the present embodiment, the player can always operate a movement of only one character with the game controller 3 or 4. That is, the player selects any one of characters belonging to any one of teams appearing in the game, as an object operated by the player, according to the situation, and gives the character the instruction to move with the game controller 3 or 4, while playing the game. For example, in case the character selected as the object possesses the ball, the player gives the character the instruction to shoot the ball, jump, pass the ball, dribble the ball or the like, with the game controller 3 or 4. On the other hand, in case the character selected as the object is at the defense side, the player gives the character the instruction to prevent the opponent character from passing the ball, cut the ball, block the ball, mark the opponent character, or the like, with the game controller 3 or 4. The characters other than the character as the object operated by the player are controlled by the processing system of the game apparatus 1, automatically. Hereinafter, the character operated by the player will be called an operated character.

On the other hand, the processing system of the game apparatus 1, controls the movement of each character on the basis of the instruction inputted from the game controller 3 or 4, the game program or the like. Then, the processing system generates the image of the virtual space including each character on the basis of the virtual camera provided in the game space, and displays the image on the display 2. Hereinafter, the virtual camera will be a view point.

The characteristic of the embodiment is to change the ability of the character possessing the ball according to the positional relation between the character possessing the ball and other characters. More specifically, when the opponent character belonging the opponent team approaches the character possessing the ball, the movement ability of the character possessing the ball is changed. Therefore, it is possible to express the psychology of the character disturbed to be marked by the opponent character, increase means of the plan for the basket ball game, and provide the realistic game.

FIG. 3 is a view showing an example of a game image 20 according to the present embodiment. More specifically, the view shows an exemplary screen just before a character 22 in a black uniform (Hereinafter, he will be called a black character.) shoots the ball. That is, the black character 22 possesses a ball 26. As shown in FIG. 3, a character 24 in a white uniform (Hereinafter, he will be called a white character.) as an opponent is not near the black character 22, that is, at the sufficient position to prevent the black character 2 from shooting the ball 26. In the case, the processing system of the game apparatus 1 according to the present embodiment makes the black character 22 display the predetermined movement ability, and shoot the ball 26.

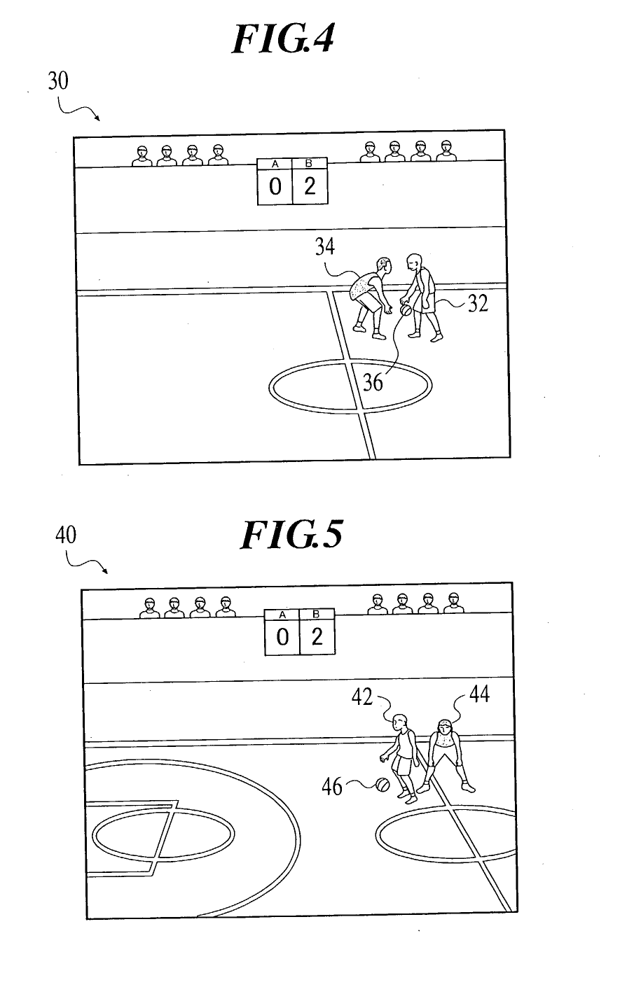

FIG. 4 is a view showing an example of a game image 30 according to the present embodiment. More specifically, the view shows an exemplary screen while a white character 32 is dribbling a ball 36. That is, the white character 32 possesses the ball 36. As shown in FIG. 4, a black character 34 is near the white character 32, that is, at the sufficient position to prevent the white character 32 from dribbling the ball 36. In the case, the processing system of the game apparatus 1 according to the present invention reduces the movement ability of the white character 32, for example, reduces the dribbling speed or reduces the probability of the success in the pass, and expresses the psychology of the white character 32 disturbed by the black character 34.

Herein, according to the present embodiment, even if the opponent character is near the character possessing the ball, in case the opponent character is behind the character possessing the character, the processing system makes the character possessing the ball move without reducing the movement ability of the character.

FIG. 5 is a view showing an example of a game image 40 according to the present embodiment. More specifically, the view shows an exemplary screen while a white character 42 is dribbling a ball 46. That is, the white character 42 possesses the ball 46. As shown in FIG. 5, although a black character 44 as the opponent is near the white character 42, the black character 44 is behind the white character 42. Therefore, the processing system of the game apparatus 1 according to the present invention makes the white character 42 go on moving without reducing the movement ability of the white character 42.

Further, according to the present embodiment, in case the character selected as the object operated by the player possesses the ball, the position of the view point, the eyes direction in the horizontal direction and the depression angle are changed automatically, according to the positional relation between the operated character and the opponent character. More specifically, when the operated character possesses the ball, and the opponent character is near the operated character, the position of the view point is changed to a close position to the operated character, to make the view of the virtual space worse. Accordingly, it is possible to not only express the psychology of the operated character possessing the ball, disturbed by the opponent character, as the result of the movement, but also express the psychology of the operated character subjectively by making the view of the circumstance worse.

For example, as shown in FIG. 4, when the black character 34 is near the white character 32 dribbling the ball 36, in case the white character 32 is the operated character, the view point is changed to a close position to the white character 32, and the eyes direction is directed to the white character 32.

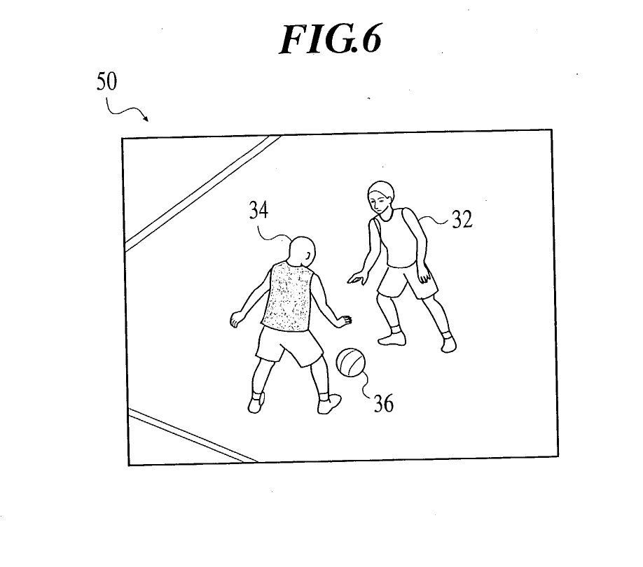

FIG. 6 is a view showing an example of a game image 50 generated in case the view point is changed to the close position to the white character 32, and the eyes direction is directed to the white character 32, in the state shown in FIG. 4. As shown in FIG. 6, because only the white character 32 and the black character 34 are displayed on the game image 50, the player cannot look out over the basket court widely. As a result, it is possible to express the anxiety of the operated character which is marked by the opponent character and cannot look out over the circumstance, subjectively, to make the player playing the game feel anxious, and to make the player have the presence.

Hereinafter, the character possessing the ball will be called a ball possessing character. The team to which the ball possessing character belongs will be called an ally team. The team as the opponent of the ally team will be called an opponent team. The character belonging to the opponent team will be called an opponent character.

Hereinafter, the present embodiment will be explained in detail.

First, the functional structure of the game apparatus 1 according to the present embodiment will be explained as follows.

FIG. 7 is a block diagram showing an example of a functional block of the game apparatus 1. As shown in FIG. 7, the game apparatus 1 comprises a processing unit 200, an input unit 100, a display unit 300, a storage unit 400 and a temporary storage unit 500.

The processing unit 200 performs various processing such as a processing for controlling the whole game apparatus 1, a processing for instructing each functional block of the game apparatus 1, a processing for advancing the basket ball game on the basis of the operation signal outputted from the input unit 100, and the game program 420 stored in the data storage 400, an image processing, a sound processing or the like. The function of the processing unit 200 can be realized by a hardware such as various processors (the CPU, the DSP or the like), the ASIC (the gate array or the like) or the like, or a predetermined program. The processing unit 200 mainly comprises a game operating unit 220 and an image generating unit 240. Therefore, the processing unit 200 makes the game operating unit 220 perform a processing according to the operation signal outputted from the input unit 100, and makes the image generating unit 240 generate the image on the basis of the result of the processing.

The game operating unit 220 performs a processing for determining various types of selection screens for the game, a processing for advancing the basket ball game, a processing for determining coordinates, a direction, a posture, a movement or the like, of each character, the ball, the object or the like, included in the game space, a processing for determining a character as the object operated by the player (that is, an operated character), a processing for determining the position of the view point and the eyes direction, or the like, for every frame. The game operating unit 220 perform the above-described processing on the basis of the operation signal outputted from the input unit 100, or the game operating program 422 stored in the storage unit 400.

Further, the game operating unit 220 according to the present embodiment, mainly comprises a positional condition determination unit 222, an ability change unit 224, a movement control unit 226, and a view point control unit 228. The game operating unit 220 makes each unit function on the basis of the game operating program 422 stored in the storage unit 400.

The image generating unit 240 performs a processing for generating a game image for every frame, on the basis of information determined by the game operating unit 220. The image generating unit 240 consists of a hardware such as the CPU, the DSP, an image generation exclusive IC, a memory or the like. More specifically, the image generating unit 240 performs a processing for performing a forward and backward clipping, and determining the view volume of the virtual space, a processing for converting coordinates of each character or the object on the basis of the view point, a processing for converting the three-dimensional virtual space coordinate system to the two-dimensional coordinate system based on the view point, or the like, for every frame, and generates the game image. Then, the image generating unit 240 stores the game image generated thereby in the temporary storage unit 500 (for example, a frame buffer or the like). The processing unit 200 outputs the game image stored in the temporary storage unit 500 to the display 300 at the necessary timing (for example, at one frame interval), and makes the display 300 display the game image thereon.

The input unit 100 is a functional unit corresponding to the game controller 3 or 4 shown in FIG. 1. The input unit 100 outputs the operation signal of the player to the processing unit 200 as an electrical signal. The input unit 100 can adopt not only the game controller 3 or 4 shown in FIG. 1, but also input means such as a mouse, a track ball, a joy stick, or the like.

The display unit 300 is a functional unit corresponding to the display 2 shown in FIG. 1. The display unit 300 reads the game image out of the temporary storage unit 500, and displays it thereon, in order, according to the instruction outputted from the processing unit 200. The display unit 300 can be realized by a display mainly connected to a computer, a display mainly used for displaying the TV broadcast.

The storage unit 400 stores a system program or data for driving the game apparatus 1 according to the present embodiment, a game program required for realizing the basket ball game, or the like, therein. The storage unit 400 can be realized by a hardware such as the CD-ROM, the MO, the DVD, a memory, a hard disc or the like. The game program 420 stored in the storage unit 400 includes a game operating program 422 and an image generating program 424.

The game operating program 422 includes a game scenario, information about a model of each character, information about each object provided in the virtual space, information as to move each object or each character according to the operation signal outputted from the input unit 100, information as to calculate the score of the basket ball game, information as to check the game time, information about peculiar value to determine the movement ability of each character, or the like. Further, the game operating program 422 includes information as to make the positional condition determination unit 222 included in the game operating unit 220 function (information as to realize the following position determination processing), information as to make the ability change unit 224 and the movement control unit 226 function (information as to realize the following movement control processing), information as to make the view point control unit 228 function (information as to realize the following view point control processing), or the like.

The image generating program 424 includes a program for making the image generating unit 240 generate the game image for every frame on the basis of the result of the processing performed by the game operating unit 220. For example, the image generating program 424 includes information as to realize a processing for converting coordinates of the object or the character provided in the virtual space to the coordinate system based on the view point, information as to realize a processing for converting the three-dimensional coordinate system based on the view point to the two-dimensional coordinate system, or the like.

The temporary storage unit 500 is a storage used as a work area of the processing unit 200. The temporary storage unit 500 is a functional unit for storing the result of the operation performed by the processing unit 200, the operation information inputted from the input unit 100, data or the program read out of the storage unit 400, or the like, temporarily. More specifically, the temporary storage unit 500 stores coordinates, the direction, the movement type and the attribute (for example, the team to which each character belongs, information as to whether each character possesses the ball or not, or the like) of each character, the time which has passed since the basket ball game starts, the score of each team, image information generated by the processing unit 200, or the like. The temporary storage unit 500 can be realized by a hardware such as the RAM, the VRAM or the like.

Hereinafter, each functional unit included in the game operating unit 220 will be explained in detail.

Hereinafter, the coordinate system for the virtual space including the basket ball court will be the world coordinate system, and expressed by (X, Y, Z). The world coordinate system is determined so that the vertical direction of the virtual space is expressed by the Y-axis, and the vertical upward direction coincides with the positive direction of the Y-axis. Further, the coordinate system of the plan perpendicular to the Y-axis will be a horizontal coordinate system, and expressed by (X, Y).

First, the positional condition determination unit 222 will be explained.

The positional condition determination unit 222 is a functional unit for determining the positional relation between characters, and determining whether the movement ability of the character possessing the ball is changed or not. More specifically, the positional condition determination unit 222 determines whether the positional relation between the character possessing the ball and the opponent character satisfies the positional condition or not. Then, in case there is an opponent character which satisfies the position condition, whenever the positional condition determination unit 222 counts the number “n” of opponent characters, the positional condition determination unit 222 stores it in the temporary storage unit 500.

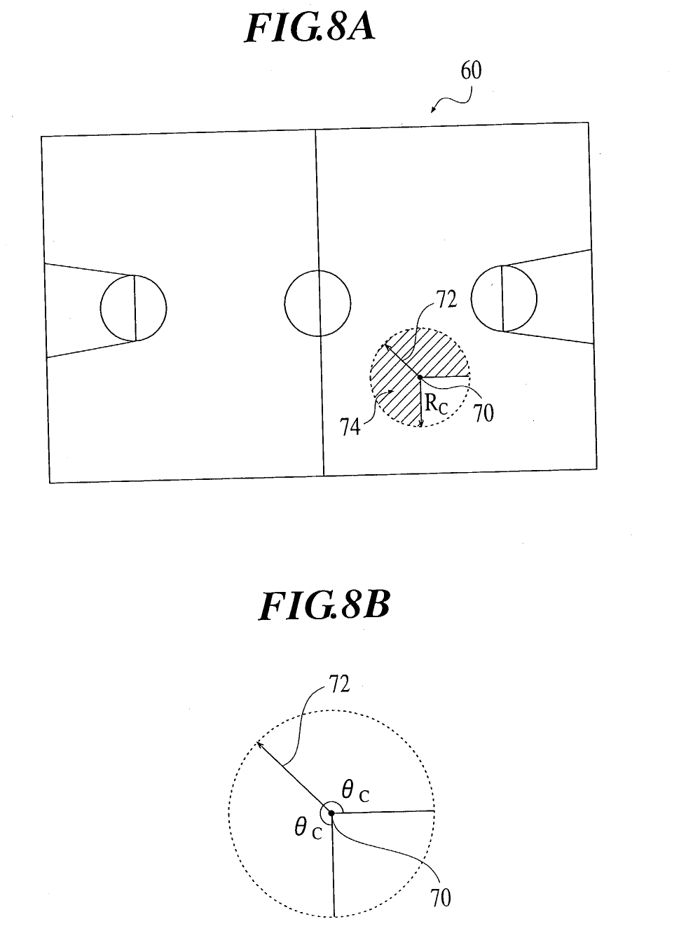

FIG. 8A is a view for explaining an example of the positional condition, and a plan view of the basket ball court 60 in the virtual space. As shown in FIG. 8A, a point 70 shows a position of the ball possessing character in the virtual space. Hereinafter, the position of each character in the virtual space is shown by one point, and the point will be called a representative point. That is, the point 70 shows the representative point of the ball possessing character. An arrow 72 having the representative point 70 as a starting point shows a direction vector of the ball possessing character in the horizontal coordinate system. That is, the ball possessing character turns in the arrow 72 in the virtual space shown in FIG. 8A.

Firstly, the positional condition determination unit 222 determines whether any opponent character is within a determination range 72 near the ball possessing character or not, in order to make the positional determination. The determination range 72 is a range corresponding to an oblique line portion shown in FIG. 8A, and means a fan-shaped portion within a radius “Rc” from the ball possessing character. That is, the positional condition determination unit 222 determines whether any opponent character is within the circular area having the radius “Rc” from the representative point 70 of the ball possessing character. When determining that any opponent character is within the circular area, the positional condition determination unit 222 determines whether any opponent character is behind the ball possessing character or not. More specifically, the positional condition determination unit 222 determines whether any opponent character is within the range (shown in FIG. 8A) having the central angle θ (−θc≦θ≦θc) of the arc having the position of the direction vector 72 as one end, of the circular area within the radius “Rc” from the representative point of the ball possessing character, or not.

On the other words, the positional condition determination unit 222 determines (1) whether any character is within the circular area having the radius “Rc” from the representative point of the ball possessing character or not, (2) whether the angle between the line connecting the ball possessing character to the character which satisfies the condition (1) and the direction vector is within the predetermined angle (−θc≦θ≦θc) or not, and (3) whether the character which satisfies the above-described conditions (1) and (2) is an opponent character or not.

Further, in case a plurality of characters which satisfy the positional conditions (1) to (3), the positional condition determination unit 222 counts the number “n” of characters. Then, the positional condition determination unit 222 stores the counted result in the temporary storage unit 500 temporarily.

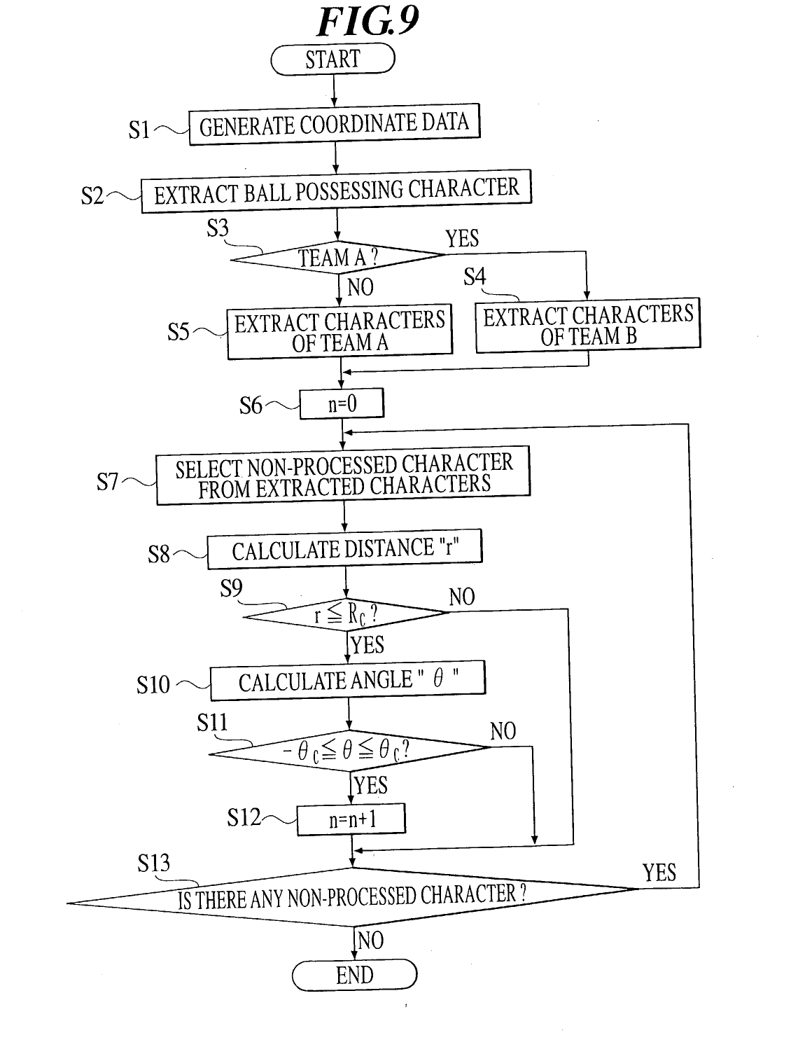

Hereinafter, the position determination processing preformed by the positional condition determination unit 222 will be explained with reference to a flow chart shown in FIG. 9. Hereinafter, the following processing may be performed for every frame, in predetermined intervals, or just before the ball possessing character takes the action. Herein, the action means a movement of the character at so-called offence, such as the shot, the pass, the dribble, the jump or the like.

First, the positional condition determination unit 222 determines coordinates of each character in the horizontal coordinate system (that is, coordinates of the representative point of each character). At the same time, the positional condition determination unit 222 determines a possession of the ball. Therefore, the positional condition determination unit 222 generates coordinate data. On the other words, the positional condition determination unit 222 determines any character of characters appearing in the basket ball game played by the user, is the ball possessing character. Then, positional condition determination unit 222 generates attribute data 520 relating each character to the attribute (for example, coordinates in the horizontal coordinate system, the ball possession, the team to which each character belongs, or the like), and restores the attribute data 520 in the temporary storage unit 500 (Step S1).

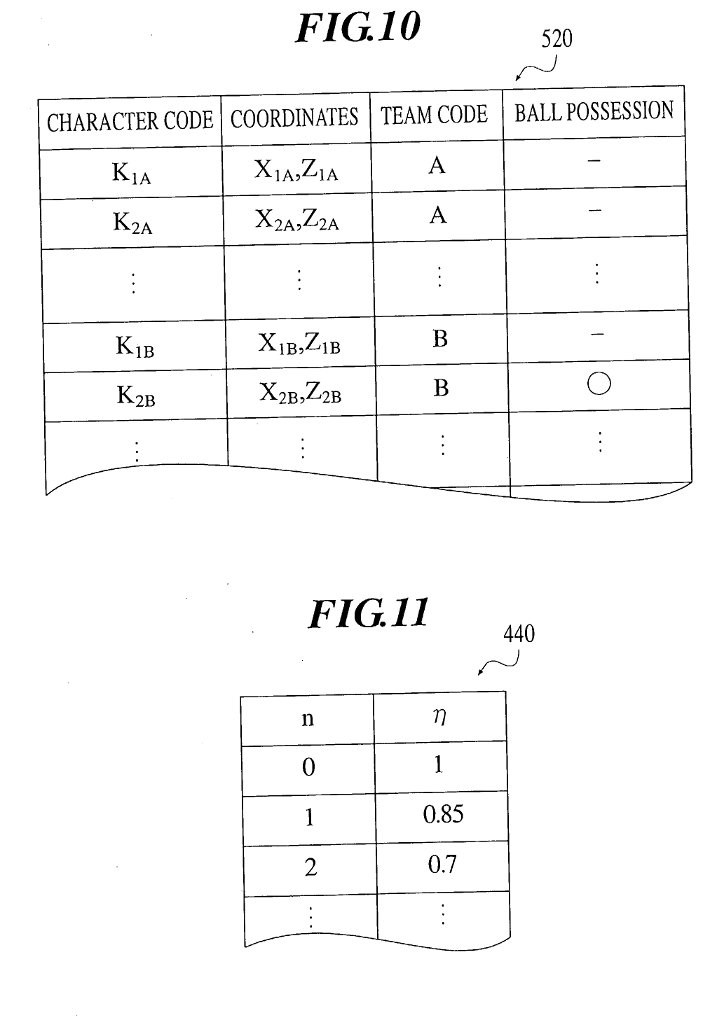

FIG. 10 is a table showing an example of the storage format of the attribute data 520. As shown in FIG. 10, the character code as the identification code of each character, coordinates in the horizontal coordinate system, the team code as the identification code of the team to which each character belongs, and the ball possession are related to each other in the attribute data 520.

Next, when the positional condition determination unit 222 extracts the information about the character possessing the ball from the attribute data 520 generated in the Step S1 (Step S2), the positional condition determination unit 222 determines which team of the teams the character (that is, the ball possessing character) belongs to (Step S3). More specifically, the positional condition determination unit 222 reads the character code, the coordinates and the team code which are related to the ball possession showing that the character possesses the ball, out of the attribute data 520. Then, the positional condition determination unit 222 determines the team to which the ball possessing character belongs, on the basis of the team code read out of the attribute data 520. According to the attribute data shown in FIG. 10, some characters belong to a team A, and others belong to a team B. Therefore, the positional condition determination unit 222 determines whether the ball possessing character read out of the attribute data 520 belongs to the team A or the team B.

When the positional condition determination unit 222 determines the team to which the ball possessing character belongs in the Step S3, the positional condition determination unit 222 reads the character code and the coordinates of each of all the opponent characters belonging to the opponent team out of the attribute data 520. For example, when determining that the ball possessing character belongs to the team A (Step S3; YES), the positional condition determination unit 222 reads information about all the characters belonging to the team B out of the attribute data 520 (Step S4). On the other hand, when determining that the ball possessing character belongs to the team B (Step S3; NO), the positional condition determination unit 222 reads information about all the characters belonging to the team A out of the attribute data 520 (Step S5).

Then, the positional condition determination unit 222 clears the variable to “0” in order to count the number “n” of opponent characters which satisfy the positional condition (Step S6). When selecting any one opponent character which has been not processed thereby, from the opponent characters extracted in the Step S4 or the Step S5 (Step S7), the positional condition determination unit 222 calculates the distance “r” between the selected opponent character and the ball possessing character (Step S8). More specifically, the positional condition determination unit 222 calculates the distance “r” on the basis of coordinates (X_{BAL}, Z_{BAL}) of the representative point of the ball possessing character and coordinates (X_{M}, Z_{M}) of the representative point of the selected opponent character in the horizontal coordinate system, according to the following equation (1).

r=√e,rad ((X_{BAL}−X_{M})²+(Z_{BAL}−Z_{M})²) (1)

Then, the positional condition determination unit 222 determines whether the distance “r” obtained by calculated in the Step S8, is equal to or smaller than the predetermined length “Rc” or not (r≦Rc) (Step S9). That is, the positional condition determination unit 222 determines whether the opponent character selected in the Step S7 is within the circular area having the radius “Rc” from the representative point of the ball possessing character or not. When determining that the calculated distance “r” is longer than the predetermined length “Rc” (r>Rc) (Step S9; NO), the positional condition determination unit 222 starts performing the processing in the Step S13, and performs the processing to the next opponent character. That is, the positional condition determination unit 222 determines whether there is any opponent character which is not processed in the opponent characters extracted in the Step S4 or the Step S5, or not (Step S13).

When determining that the distance “r” is not longer than the predetermined length “Rc” (r≦Rc) (Step S9; YES), and that the positional condition is satisfied, the positional condition determination unit 222 calculates the angle “θ” between the line connecting the opponent character extracted in the Step S7 to the ball possessing character, and the direction vector of the ball possessing character (Step S10). More specifically, the positional condition determination unit 222 calculates the unit vector “U” of the line connecting the representative point of the extracted opponent character to the representative point of the ball possessing character (the representative point of the ball possessing character is the starting point), and calculates the angle “θ” according to the inner product (U·D) and the outer product (U×D) of the unit vector “U” and the direction vector “D” of the ball possessing character, according to the following equation (2).

θ=tan ⁻¹{|U×D|/(U·D)} (2)

Herein, |U×D| means the scalar of the outer product “U×D”.

Then, the positional condition determination unit 222 determines whether the angle “θ” obtained by calculating in the Step S10, satisfies the condition (−θc≦θ≦θc) or not (Step S1). That is, the positional condition determination unit 222 determines whether the opponent character extracted in the Step S7 is within the oblique line range 74 shown in FIG. 8, or not. When determining that the angle “0” does not satisfies the condition (−θc≦θ≦θc) (Step S11; NO), the positional condition determination unit 222 starts performing the processing in the Step S13, and determines whether there is any opponent character which is not processed, in the opponent characters extracted in the Step S4 or the Step S5 (Step S13). On the other hand, when determining that the angle “θ” satisfies the condition (−θc≦θ≦θc) (Step S11; YES), the positional condition determination unit 222 adds “1” to the variable “n” to count the number of opponent characters which satisfy the positional condition (n=n+1) (Step S12). Then, the positional condition determination unit 222 starts performing the processing to the next opponent character. That is, the positional condition determination unit 222 determines whether there is any opponent character which is not processed, in the opponent characters extracted in the Step S4 or the Step S5, or not (Step S13).

When determining that there is any opponent characters which is not processed, in the opponent characters extracted in the Step S4 or the Step S5 (Step S13; YES), the positional condition determination unit 222 goes back to and starts performing the processing in the Step S7. On the other hand, when determining that all of the opponent characters extracted in the Step S4 or the Step S5 are processed (Step S13; NO), the positional condition determination unit 222 stores the number “n” counted thereby, in the temporary storage unit 500, and ends the position determination processing.

As described above, when the positional condition determination unit 222 determines the positional relation between the ball possessing character and the opponent character in the virtual space, the positional condition determination unit 222 determines whether there is any opponent character which satisfies the positional condition or not. In the case there is an opponent character which satisfies the positional condition, the positional condition determination unit 222 counts the number “n” of opponent characters, and restore it in the temporary storage unit 500.

It is unnecessary that the determination range to determine the positional relation between the ball possessing character and the opponent character, is limited to the shape like the oblique line range 74 shown in FIG. 8. The determination range may be any shape. Further, the value of the radius “Rc” or the threshold “θc” may be changed as the game time passes, or for every character. Further, it is unnecessary that the distance “r” or the angle “O” between the characters is calculated according to the equation (1) or (2). The distance “r” or the angle “θ” may be calculated according to data in a table format, or another calculating method.

Next, the ability change unit 224 will be explained.

The ability change unit 224 is a functional unit for performing a processing for changing the movement ability of the ball possessing character according to the number “n” of opponent characters which satisfy the positional condition.

According to the present embodiment, the ability change unit 224 determines the movement ability (or the own movement) of the ball possessing character on the basis of the proper value (fixed value) to the character. Herein, in case there is any opponent character which satisfies the above-described conditions (1) to (3), when multiplying the proper value by the numeral value “η” changing the number “n” of opponent characters, the ability change unit 224 changes the movement ability. On the other words, the ability change unit 224 performs a processing for changing the default proper value to each character (the predetermined value), that is a processing for calculating the value “η” so as to change according to the number “n”. Further, according to the present embodiment, the ability change unit 224 changes the numeral value “η” so that the movement ability of the ball possessing character reduces as the number “n” of opponent characters which satisfy the positional condition increases. Herein, the value “η” will be called a change coefficient “η”.

The proper value is a numeral value, for example, a moving speed “v_{D}” when dribbling the ball, a height “h” when jumping, an aim range “ΔV” for shooting or passing the ball, a probability “C” of success of a special technique (for example, a dunk shot or the like). Herein, the aim range “ΔV” will be explained in detail, as follows. The aim range “ΔV” is a value showing a probability that the ball reaches the desired position. The larger aim range “ΔV” shows that the shot or the pass is inaccurate, or the smaller aim range “ΔV” shows that the possibility that the ball is passed accurately.

In order to reduce the movement ability of the ball possessing character as the number “n” of opponent characters which satisfy the positional conditions increases, the change coefficient “η” is defined as the decreasing function which decreases as the “n” increases. Herein, while the number “n” is equal to or larger than “0” (n≧0), the change coefficient “η” is always larger than “0” (η>0). For example, the change coefficient “η” is defined by using the following exponential function (3) or the like.

η(n)=exp{−αn} (3)

Herein, “α” is the constant which is larger than “0” and smaller than “1” (0<α<1). The constant “α” relaxes the rapidly decreasing of the change coefficient “η” as the change of the variable “n” . According to the function (3), when the variable “n” is equal to “1”, the change coefficient “η” is equal to “1”. The reason to use the above-described function, is that when any opponent character does not satisfy the positional conditions, the ball possessing character shows the given movement ability. For example, in case of multiplying the predetermined dribbling speed “v_{D}” by “η” shown in the function (3) (v_{D}η), when “n” is not equal to “0” (n≠0), because “η” is smaller than “1” (η<1), “v_{D}” is larger than “v_{D}η” (v_{D}>v_{D}η), and the moving speed when dribbling the ball is decreased. When “n” is equal to “0” (n=0), because “η” is equal to “1” (η=1), “v_{D}” is equal to “v_{D}η” (v_{D}=v_{D}η), and it is possible to show the moving speed when dribbling the ball.

Herein, it is unnecessary that the method for determining the change coefficient “η” is limited to the method for determining it according to the function η (n) with the variable “n”. For example, the change coefficient “η” may be determined by using data in a table format previously relating the “n” value to the “η” value.

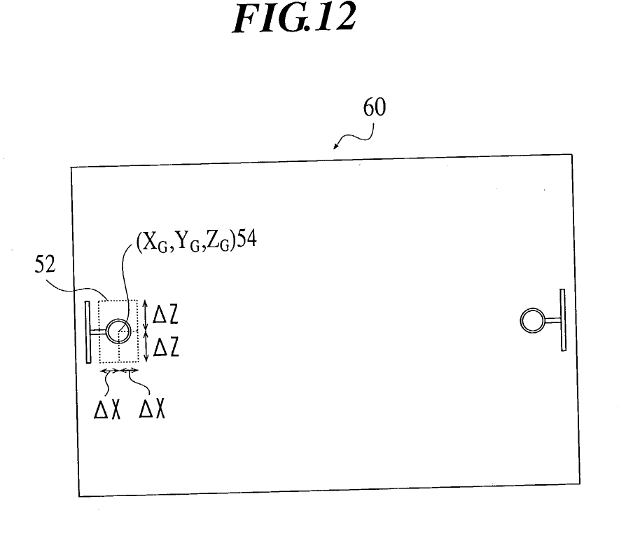

FIG. 11 is a table showing an example of a relative table 440 relating “n” to “η”. In case of using the relating table 440, when the positional condition determination unit 222 determines the number “n” of opponent characters, the ability change unit 224 reads the value of the change coefficient “η” corresponding to the number “n” out of the relative table 440.

Next, the movement control unit 226 will be explained.

The movement control unit 226 is a functional unit for controlling the ball possessing character on the basis of the change coefficient “η” determined by the ability change unit 224, and the proper value for determining the movement ability of the character.

Hereinafter, some exemplary methods for changing the movement ability will be explained.

It is possible to give a plurality of types of movements of the ball possessing character, that is, the character at the offence side. Herein, the jump, the dribble, the general shot, the pass, and the special technique (for example, a dunk shot) will be explained as an example.

First, the jump and the dribble will be explained.

According to the present invention, the proper value by which the jump ability is characterized, is a height “h” of the peak of the jump. The proper value by which the dribble ability is characterized, is a moving speed “v^{D}” when dribbling the ball. That is, it is possible that the character having the larger proper value “h” jumps higher, and the character having the larger proper value “v_{D}” moves at the higher speed with dribbling the ball in the virtual space. Therefore, for example, the movement control unit 226 reads the proper value “h” of the ball possessing character out of the storage unit 400, and determines the height of the peak of the jump, in order to make the ball possessing character jump. Further, the movement control unit 226 reads the proper value “v_{D}” of the ball possessing character out of the storage unit 400, and determines the moving speed when dribbling the ball, in order to make the ball possessing character dribble the ball.

The movement control unit 226 uses not the proper value “h” or the proper value “¹v_{D}” read out of the storage unit 400, as it is, in order to make the ball possessing character jump or dribble, but multiplies the proper value “h” or the proper value “v_{D}” by the change coefficient “η” determined by the ability change unit 224 and uses the multiplied value. The change coefficient “η” decreases as the number “n” of opponent characters increase. Therefore, when the movement control unit 226 multiplies the proper value “h” or “v_{D}” by the change coefficient “η”, because “n” is larger than “0” (n>0), the height of the jump lowers, or the moving speed when dribbling lowers. On the other hand, in case there is any opponent character which satisfies the positional conditions (n=0), because “η” is equal to “1” (T=1), it is possible that the ball possessing character shows the proper jump ability or the proper dribble speed.

Next, the shot or the pass will be explained.

According to the present invention, the above-described aim range “ΔV” is used as the proper value by which the ability of the shot or the pass is characterized. The aim range “ΔV” shows the range in the virtual space. More specifically, the aim range “ΔV” shows the volume (ΔV=2ΔX×2ΔY×2ΔZ) in the world coordinate system.

In order to make the ball possessing character shoot or pass the ball, a target reach position of the ball is previously determined. For example, in order to make the ball possessing character shoot the ball, the target reach position is determined just above the goal of the opponent team. Further, in order to make the ball possessing character pass the ball, the target reach position is determined at the representative position of the character to which the ball possessing character passes the ball. According to the present embodiment, in order to make the ball possessing character shoot or pass the ball, the movement control unit 226 firstly determines the target reach position of the ball, and then, provides the aim area “ΔV” having the target reach position as the center, as the “selectable range” of the position the ball reaches, in the world coordinate system. Then, the movement control unit 226 determines the position the ball reaches within the “selectable range” determined in the world coordinate system, according to random numbers. Therefore, when determining the course of the ball on the basis of the determined position the ball reaches and the position of the ball possessing character, the movement control unit 226 moves the ball along the course.

For example, in order to make the ball possessing character shoot the ball, the movement control unit 226 reads coordinates (X_{G}, Y_{G}, Z_{G}) just above the goal of the opponent team, and the aim range (ΔX, ΔY, ΔZ) determined for every character, out of the storage unit 400, and determines the selectable range.

(X_{G}−ΔX≦X≦X_{G}+ΔX)

(Y_{G}−ΔY≦Y≦Y_{G}+ΔY)

(Z_{G}−ΔZ≦Z≦Z_{G}+ΔZ)

The selectable range shows the range of the aim range ΔV having the coordinates (X_{G}, Y_{G}, Z_{G}) just above the goal as the center. Then, the movement control unit 226 determines the position the ball reaches within the determined selectable range.

FIG. 12 is a plan view of the court 60 in the virtual space, showing an exemplary of the selectable range of the position the ball reaches. As shown in FIG. 12, the plane area (2ΔX×2ΔZ) of the selectable range 52 is larger than the range that the ball reaches the goal certainly. Therefore, when the movement control unit 226 determines the position the ball reaches in the selectable range 52, according to random numbers, there is a possibility that the movement control unit 226 determines the position the ball reaches other than the position the ball reaches the goal certainly. On the other words, the smaller the aim range ΔV is, the stronger the possibility that the ball reaches the goal is. On the other hand, the larger the aim range ΔV is, the weaker the possibility that the ball reaches the goal is.

However, the movement control unit 226 uses not the value of the aim range ΔV read out of the storage unit 400, as it is, as the proper value of the pass or the shot, but changes the aim range ΔV by the change coefficient “η” determined by the ability change unit 224, and uses the changed value. More specifically, the movement control unit 226 multiplies each of coordinates (ΔA, ΔY, ΔZ) of the aim range ΔV by the change coefficient “η” That is, because the value of the reciprocal number (1/η) of the change coefficient becomes larger, as the number “n” of opponent characters increases, the aim range ΔV becomes larger, and the possibility of success in the shoot or the pass becomes weaker. In case there is not any opponent character which satisfies the positional condition, that is, in case “n” is equal “0” (n=0), it is possible to make the ball possessing character shoot or pass the ball in the proper aim range ΔV to the ball possessing character.

Next, the special technique such as the dunk shot will be explained.

The proper value for determining the movement ability of the special technique is defined by the probability “C” of success in the movement. That is, it is determined whether the movement succeeds or not, according to the probability “C” of success in the movement. For example, in case the probability “C” of success in the special technique is 30%, the movement control unit 226 generates the random number “ξ” of values which is equal to or larger than “1” and smaller than “100” (1≦ξ<100), and determines whether the generated random number “ξ” is within the numeral range which is equal to or larger than “1” and small than “30” or not (1≦ξ<30). In the random number “ξ” is within the numeral range, the movement control unit 226 makes the ball possessing character move so as to succeed in the special technique. On the other hand, in case the random number “ξ” is not within the numeral range, the movement control unit 226 makes the ball possessing character move so as to fail in the special technique.

More specifically, the movement control unit 226 receives the instruction to make the ball possessing character execute the special technique, the movement control unit 226 reads the proper value “C” of the special technique out of the storage unit 400, and determines whether the ball possessing character executes the special technique or not. The movement control unit 226 uses not the read proper value C, as it is, but multiplies the proper value “C” by the change coefficient “η” calculated by the ability change 224, and uses the multiplied value. Because the change coefficient “η” decreases as the number “n” of opponent characters increases, when the proper value “C” is multiplied by the change coefficient “η”, the probability of success becomes weaker, as the number “n” of opponent characters increases. On the other hand, in case there is not any opponent character which satisfies the positional conditions (n=0), because the change coefficient “η” is equal to “1” (η=1), the movement control unit 226 determines whether the ball possessing character succeeds in the special technique or not, according to the proper probability of success to the ball possessing character.

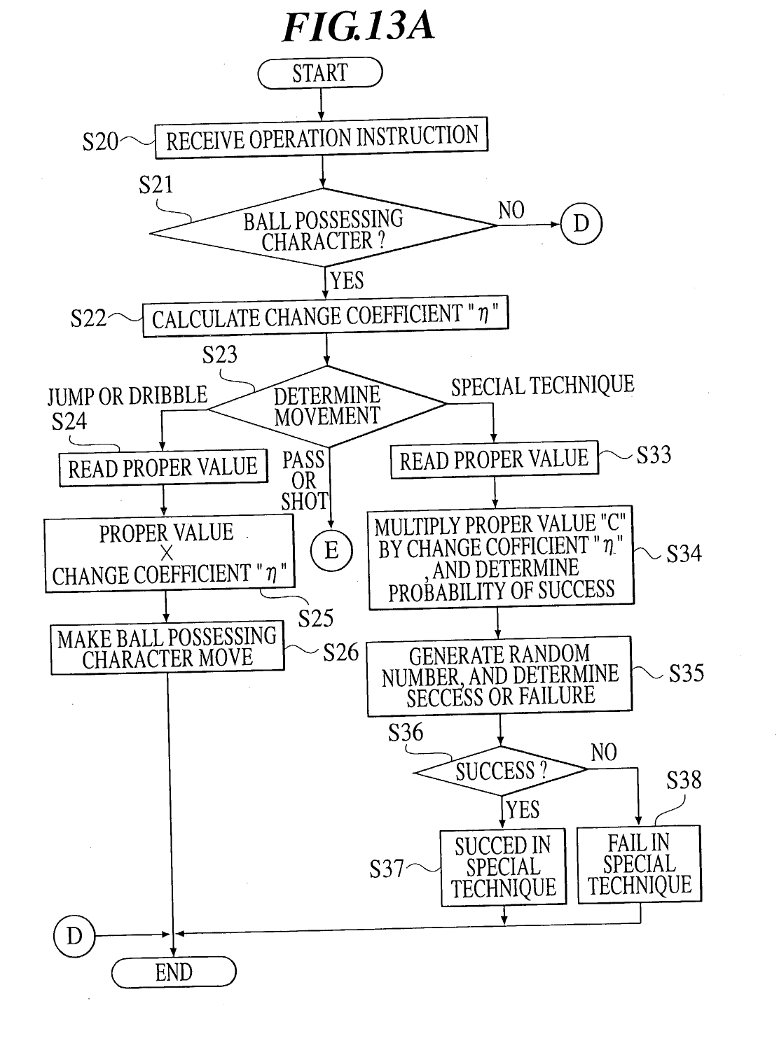

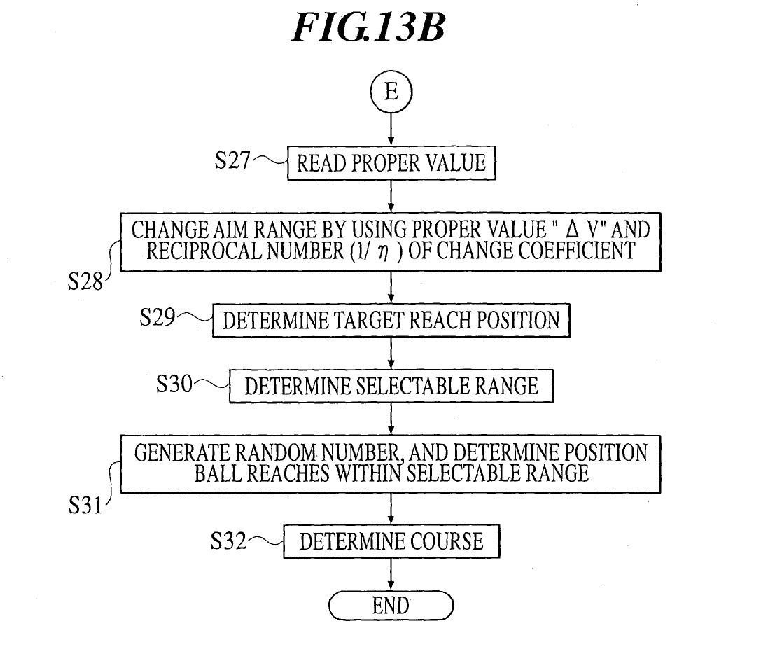

Hereinafter, the movement control processing performed by the ability change unit 224 and the movement control unit 226, will be explained with reference to flow charts shown in FIGS. 13A and 13B. The movement control processing is a processing for controlling the movement of the ball possessing character. The following movement control processing is continuously executed even when the input unit 100 outputs the instruction to make the character move.

According to the movement control processing, when the game operating unit 220 receives the operation instruction to make the character move according to the result of the processing based on the game program 420, or the instruction outputted from the input unit 100 (Step S20), the game operating unit 220 determines whether the character is a ball possessing character or not, on the basis of the ability data 520 (shown in FIG. 10) generated by the positional condition determination unit 222 (Step S21). When determining that the character is not a ball possessing character (Step S21; NO), game operating unit 220 ends the present movement control processing, and makes the character moves as usually.

When determining that the character is a ball possessing character (Step S21; YES), the ability change unit 224 calculates the change coefficient “η” (Step S22). More specifically, the ability change unit 224 reads the number “n” of opponent characters stored in the temporary storage unit 500 according to the position determination processing as shown in FIG. 9, and calculates the change coefficient “η” on the basis of the number “n”.

Then, the movement control unit 226 determines the types of the movement to be executed by the ball possessing character, according to the result of the processing based on the game program 420, or the content of the instruction outputted from the input unit 100 (Step S23).

In the Step S23, when determining that the movement to be executed by the ball possessing character is the jump or the dribble, the movement control unit 226 reads the proper value corresponding to the jump or the dribble out of the storage unit 400 (Step S24). For example, in order to make the ball possessing character jump, the movement control unit 226 reads the proper value “h” of the jump power of the ball possessing character out of the storage unit 400. Further, in order to make the ball possessing character dribble the ball, the movement control unit 226 reads the proper value “v_{D}” of the dribble speed of the ball possessing character out of the storage unit 400. Then, when multiplying the read proper value by the change coefficient “η” calculated in the Step S22, the movement control unit 226 determines the movement ability of the ball possessing character (Step S25). For example, in order to make the ball possessing character jump, the movement control unit 226 multiplies the proper value “h” by the change coefficient “η”, and determines the height of the peak of the jump. Further, in order to make the ball possessing character dribble the ball, the movement control unit 226 multiplies the proper value “v_{D}” by the change coefficient “η”, and determines the moving speed when dribbling the ball. The movement control unit 226 makes the ball possessing character move on the basis of the determined movement ability (Step S26).

In the Step S23, when determining that the movement to be executed by the ball possessing character is the shot or the pass, the movement control unit 226 reads the proper value “ΔV” corresponding to the shot or the pass of the ball possessing character, out of the storage unit 400 (Step S27). Then, the movement control unit 226 changes the value of the aim range of the pass or the shot, by using the reciprocal number (1/η) of the change coefficient “η” calculated by the ability change unit 224 in the Step S22, and the proper value “ΔV” (the aim range) (Step S28). More specifically, the movement control unit 226 multiplies each of (ΔA, ΔY, ΔZ) of the proper value ΔV, by the reciprocal number (1/η).

Then, the movement control unit 226 determines the target reach position of the ball (Step S29). For example, in order to make the ball possessing character shoot the ball, the movement control unit 226 determines the position (X_{G}, Y_{G}, Z_{G}) just above the goal of the opponent team, as the target reach position. Further, in order to make the ball possessing character pass the ball, the movement control unit 226 determines coordinates (Xₚ, Yₚ, Zₚ) of the representative point of the character to which the ball possessing character passes the ball, as the target reach position. Thereafter, the movement control unit 226 determines the selectable range by using the aim range (ΔX, ΔY, ΔZ) changed in the Step S28, so that the target reach position is the center point (Step S30).

When determining the selectable range, the movement control unit 226 generates a random number, and determines the position the ball reaches within the selectable range, according to the random number (Step S31). Then, the movement control unit 226 determines the course of the ball on the basis of the position the ball reaches and the coordinates of the representative point of the ball possessing character (Step S32), and moves the ball.

In the Step S23, when determining that the movement to be executed by the ball possessing character is the special technique, the movement control unit 226 reads the proper value “C” of the special technique of the proper values corresponding to the ball possessing character, out of the storage unit 400 (Step S33). Then, the movement control unit 226 multiplies the proper value “C” by the change coefficient “η” calculated in the Step S22, and determines the probability of success in the special technique (Step S34). Then, the movement control unit 226 generates a random number, and determines whether the ball possessing character succeeds in the special technique or fails in the special technique, on the basis of the random number and the probability of success (Step S35). When determining to make the ball possessing character succeed (Step S35; YES), the movement control unit 226 makes the ball possessing character execute the special technique so as to succeed in the special technique (Step S37). On the other hand, when determining to make the bal possessing character fail (Step S35; NO), the movement control unit 226 makes the ball possessing character execute the special technique so as to fail in the special technique (Step S38).

When finishing the processing for determining in the Step S23, the movement control unit 226 ends the present movement control processing.

As described above, the ability change unit 224 calculates the change coefficient “η” on the basis of the number “n” of opponent characters which satisfy the positional conditions. Then, the movement control unit 226 determines the movement ability, the success or failure in the movement, or the like, on the basis of the predetermined proper value to each character and the change coefficient “η”.

According the above-described explanation, it has been explained that the proper value to each character is used as the parameter for determining the movement ability, and constant. However, the parameter is not limited to the proper value. A variable value changing with the passage of game time, or according to the distance between the character and the arbitrary object may be used as the parameter for determining the movement ability. For example, the movement ability may be determined by a variable value changing according to the distance between the object such as the ball, the goal or the like and the character.

Further, the parameter (ΔA, ΔY, ΔZ) by which the ability of the pass is characterized may be a variable value changing according to the distance “L” between the ball possessing character and the character to which the ball possessing character passes the ball. For example, when the character to which the ball possessing character passes the ball is near the ball possessing character, the parameter (ΔA, ΔY, ΔZ) may be determined so that the value of each element is small, or when the character is far from the ball possessing character, the parameter (ΔA, ΔY, ΔZ) may be determined so that the value of each element is large. In the case, it is possible to change the movement ability by multiplying each parameter by the change coefficient (1/η).

Next, the view point control unit 228 will be explained.

The view point control unit 228 is a functional unit for determining the position and the direction (that is, the eyes direction) of the view point, while executing the game, for every frame.

According to the present embodiment, when the following two conditions are satisfied, the view point control unit 228 approaches the view point to the ball possessing character.

Condition “a”: the operated character is the ball possessing character.

Condition “b”: any opponent character satisfies the positional conditions (1) to (3).

First, the method for determining the position of the view point usually, that is, when the above-described conditions are not satisfied, will be explained.

Hereinafter, in order to explain the method more simply, usually, the depression angle “τ_{O}”, the view angle “Φ_{O}”, and the height “Y_{V}” of the view point are determined to be constant, and the eyes direction of the view point in the horizontal coordinate system is determined to be parallel to the Z axis.

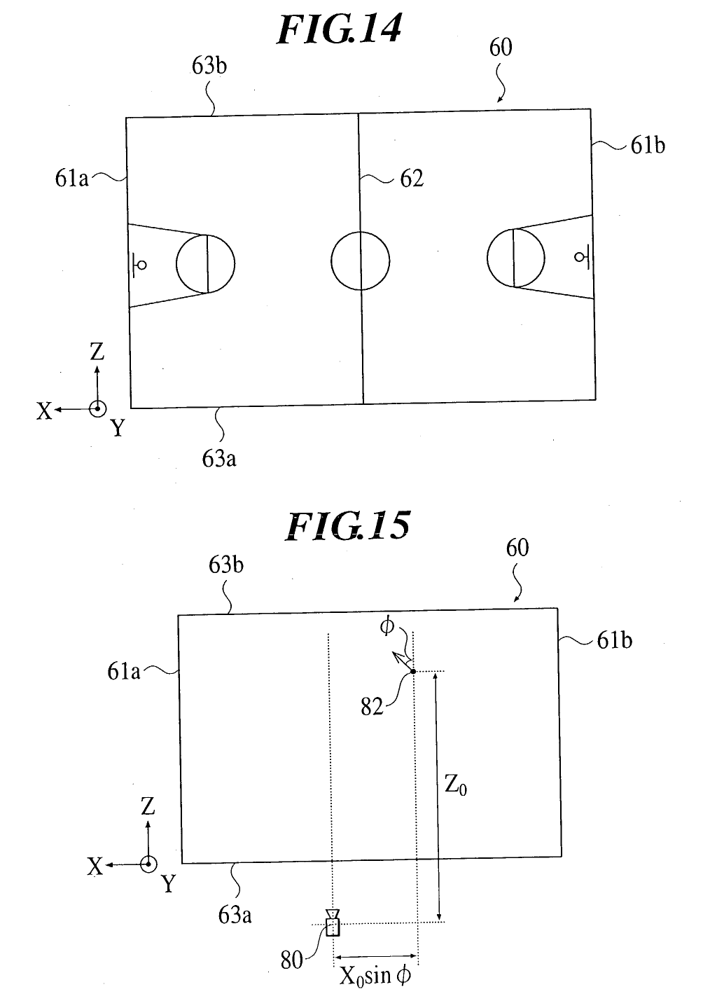

FIG. 14 is a plan view of the basket ball court 60 in the virtual space. Hereinafter, the basket ball court 60 will be called a court 60 simply. As shown in FIG. 14, end lines 61a and 61b, and a center line 62 are parallel to the Z axis, and side lines 63a and 63b are parallel to the X axis. That is, the view point is moved parallel, in the virtual space, so that the eyes direction is always parallel to the end lines 61a and 61b and the center line 62. As described above, the Y axis is determined so as to indicate the vertical upward direction in the virtual space, and each coordinate axis is determined so that the outer product (XXY) indicates the positive direction of the Z axis.

Usually, the view point control unit 228 determines the horizontal coordinates (X_{V}, Z_{V}) of the view point according to the following equations (4) and (5) using the horizontal coordinates (X_{CH}, Z_{CH}) and the direction vector of the operated character.

X_{V}=X_{CH}+X_{O}sin φ (4)

Z_{V}=Z_{CH}+Z_{O} (5)

Herein, coordinates (X_{O}, Z_{O}) are constants. Further, “φ” shows an angle between the direction vector of the operated character and the Z axis.

FIG. 15 is a plan view, and a view for explaining the positional relation between the operated character 82 and the view point 80 on the basis of the equations (4) and (5). Only the end lines 61a and 61b and the side lines 63a and 63b are shown in, and other lines are omitted from FIG. 15.

According to the equation (4), the view point control unit 228 determines the X coordinate of the view point, within the range of the amplitude X_{O} from the representative point of the operated character, as the center point, according to the angle “φ” between the direction vector of the operated character and the Z axis. For example, in case the direction vector is parallel to the Z axis (φ=0, π), the view point control unit 28 determines the X coordinate “X_{V}” of the view point to be “X_{CH}” (X_{V}=X_{CH}), that is, the same as the X coordinate of the operated character. In case the angle “φ” between the direction vector and the Z axis is “π/2” (φ=π/2), the view point control unit 28 determines the X coordinate “X_{V}” of the view point to be “X_{CH}+X_{O}” (X_{V}=X_{CH}+X_{O}). In case the angle “φ” between the direction vector and the Z axis is “−π/2” (φ=−π/2), the view point control unit 28 determines the X coordinate “X_{V}” of the view point to be “X_{CH}−X_{O}” (X_{V}=X_{CH}−X_{O}) That is, the view point is always arranged in the direction of the operated character. Further, according to the equation (5), the distance between the operated character in the Z direction and the view point is always kept “Z_{O}” which is constant, and the view point is always arranged at one side line 63a of the court 60. On the other words, usually, the depth position of the operated character to the view point, and the eyes direction are always constant, and the same size of operated character is always expressed on the screen.

Next, the method for arranging the view point, when the above-described two conditions are satisfied, will be explained. Herein, even if the conditions “a” and “b” are satisfied, the height “Y_{V}” of the view point and the view angle “ω_{O}” are constant.

In case the above-described two conditions “all and “b” are satisfied, that is, in case the operated character possesses the ball, and there is any opponent character which satisfies the positional conditions, the view point control unit 228 approaches the view point to the operated character, and changes the eyes direction. More specifically, the view point control unit 228 approaches the view point to the operated character, as the number “n” of opponent characters which satisfy the positional conditions increases, and approaches the view point to the operated character, as the shortest distance “r_{MIN}” between the opponent character which satisfies the positional conditions and the operated character is shortened. That is, the view point control unit 228 calculates the function ξ (n, r) decreasing as the number “n” increases, or decreasing as the distance “r_{MIN}” is shortened, and multiplies the constants (X_{O}, Z_{O}) included in the functions (4) and (5) by the function ξ (n, r).

X_{V}=X_{CH}+X_{O}ξ sin φ (6)

Z_{V}Z_{CH}+Z_{O}ξ (7)

Because the function ξ is a function decreasing as the number “n” of opponent characters increases or decreasing as the distance “r_{MIN}” is shortened, the view point control unit 228 approaches the X coordinate and the Z coordinate of the view point to the representative point of the operated character, according as the number “n” increases, or the distance “r_{MIN}” is shortened.

The function “ξ” may be any function decreasing as the number “n” increases, or the distance “r_{MIN}” is shortened (or “1/r_{MIN}” increases) For example, the function “ξ” may adopt the following exponential function (8).

ξ=exp{−(βn+γ/r_{MIN})} (8)

Herein, each of “β” and “γ” is a positive constant which is smaller than “1”. According to “β” and “γ”, it is possible to relax the rapid change of “n” or “r_{MIN}”.

Further, the view point control unit 228 approaches the position of the view point to the operated character, and further directs the eyes vector to the operated character in the horizontal coordinate system. More specifically, the view point control unit 228 turns the eyes vector by “τ_{Y}” around the Y axis, in the state of turning in the Z axis.

τ_{Y}=tan ⁻¹{−X_{O} sin φ/Z_{O}} (9)

However, when the view point control unit 228 multiplies the constant “Z_{O}” by the function “ξ38 as shown in the function (8), the depth position of the operated character to the view point is changed. Because the function “ξ” is the decreasing function for the “n” and “1/r_{MIN}”, the view point approaches the operated character, as the number “n” of opponent characters which satisfy the positional conditions increases, or the nearest opponent character approaches the operated character. Herein, because the height “Y_{V}” of the view point is constant, if the depression angle “τ_{O}” is kept constant, the operated character moves downward from the center on the screen, and disappears, as the view point approaches the operated character.

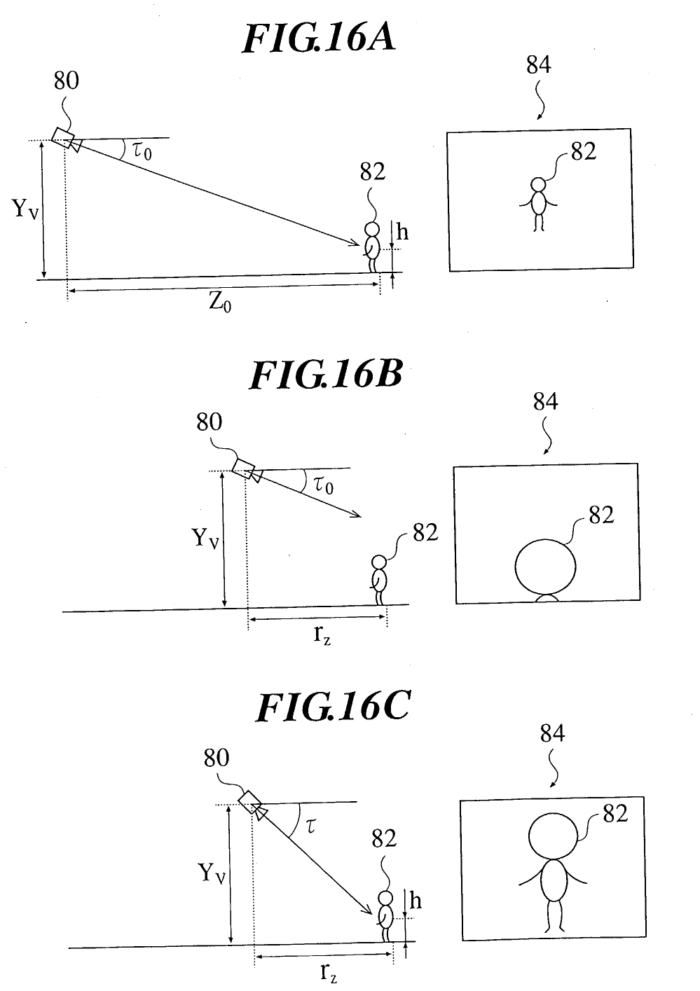

FIGS. 16A, 16B and 16C are views for explaining positional relations between the operated character and the view point in the virtual space, and exemplary screens corresponding to the positional relations, respectively. FIG. 16A is a view showing an usual positional relation between the view point 80 and the operated character 82, and an exemplary screen corresponding to the positional relation. Usually, the depth “Z_{O}” of the operated character 82 is always constant, and the depression angle “τ_{O}” is determined so that the operated character 82 is positioned near the center of the screen. However, when the view point control unit 228 approaches the view point 80 to the operated character 82 with keeping the depression angle “τ_{O}” constant, because the eyes direction of the view point 80 passes over the head of the operated character 82, the object, that is, the operated character 82, is not displayed near the center of the screen, as shown in FIG. 16B. Therefore, the view point control unit 228 changes the depression angle “τ_{O}” so that the eyes direction of the view point 80 passes near the height of the representative point of the operated character 82. More specifically, the view point control unit 228 calculates the height “h” (the height of the head or the body of the operated character 82) of the object on the basis of the distance “r_{Z}” between the view point 80 and the operated character 82, according to the following equation (10).

τ=tan ₋₁{(Y_{V}−h)/_{Z}} (10)

Therefore, because the view point control unit 228 changes the depression angle “τ” according to the positional relation between the view point 80 and the operated character 82, it is possible to display the operated character 82 near the center of the screen, as shown in FIG. 16C.

The method for determining the value of the coefficient “τ” for changing the distance between the operated character and the view point, is not limited to the method for determining the value of the coefficient “τ” according to the function (8) of the variables “n” and ”1/r_{MIN}”. It is needless to say that the value of the coefficient “τ” may be determined according to data in a table format which relates the value of “n” or “1/r_{MIN}” to the value of “τ”.

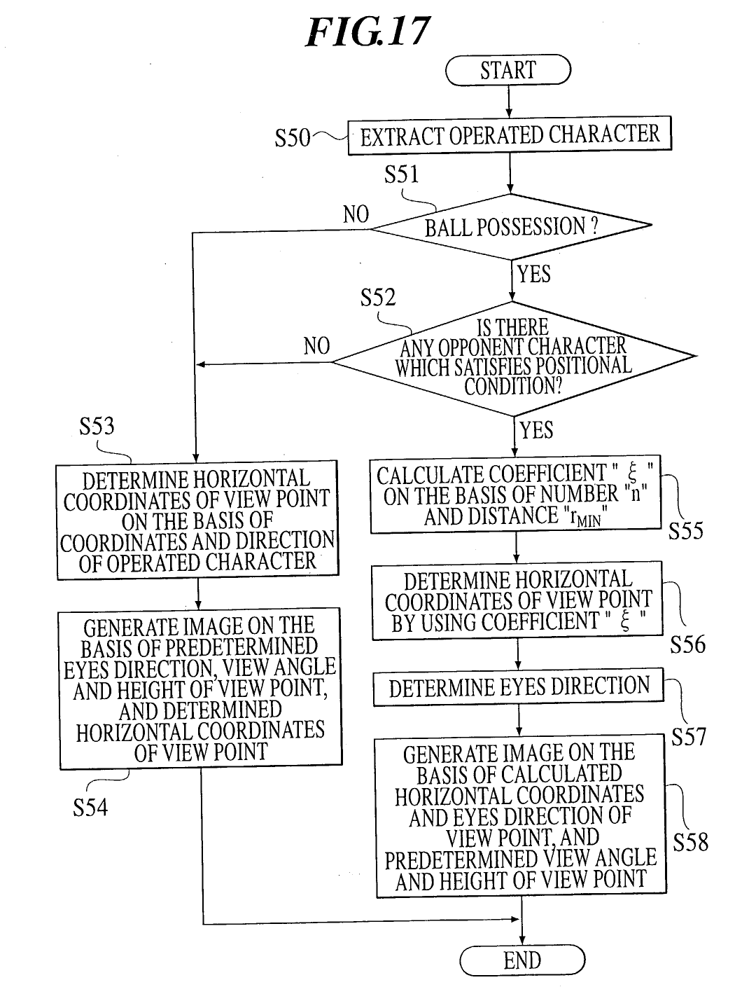

Next, the processing (the view point control processing) performed by the view point control unit 228 will be explained with reference to a flow chart shown in FIG. 17. The view point control unit 228 performs the following processing for every frame.

As shown in FIG. 17, the view point control unit 228 extracts the operated character from the ability data 520 generated by the positional condition determination unit 222 (Step S50). Then, the view point control unit 228 determines whether the extracted operated character possesses the ball or not (Step S51). When determining that the operated character does not possess the ball (Step S51; NO), the view point control unit 228 starts performing the processing in the Step S53, to determine the position of the usual view point. On the other hand, when determining that the operated character possesses the ball (Step S51; YES), the view point control unit 228 determines whether there is any opponent character which satisfies the positional conditions or not, that is, whether the number “n” of opponent characters, stored in the temporary storage unit 500, is “0” or not, on the basis of the result of the processing performed by the positional condition determination unit 222 (Step S52). When determining that there is not any opponent character which satisfies the positional conditions (Step S52; NO), the view point control unit 228 starts performing the processing in the Step S53, to determine the position of the view point. Usually, that is, when determining that the operated character does not possess the ball (Step S51; NO), or that there is not any opponent character which satisfies the positional conditions (Step S52; NO), the view point control unit 228 determines horizontal coordinates (X_{V}, Z_{V}) of the view point according to the equations (4) and (5) (Step S53). That is, the view point control unit 228 substitutes the horizontal coordinates (X_{CH}, Z_{CH}) and the angle “φ” between the direction vector and the Z axis, of the operated character, for the equations (4) and (5), and thereby determines the horizontal coordinates of the view point. Then, the view point control unit 228 makes the image generating unit 240 generate the image on the basis of the depression angle “τ_{O}”, the view angle “ω_{O}”, the height “Y_{V}”, and the eyes direction in the horizontal coordinate system, of the view point, which are previously determined, and the horizontal coordinates (X_{V}, Z_{V}) of the view point, which is determined in the Step S53 (Step S54), and ends the view point control processing for one frame.

On the other hand, when determining that the operated character possesses the ball (Step S51; YES), and that there is any opponent character which satisfies the positional conditions (Step S52; YES), the view point control unit 228 determines the position of the view point on the basis of the result of the processing performed by the positional condition determination unit 222, as follows. That is, the view point control unit 228 calculates the coefficient “ξ” on the basis of the number “n” of opponent characters which satisfy the positional conditions, and the shortest distance “r_{MIN}” of the distances between the opponent characters which satisfy the positional conditions and the operated character (Step S55). Then, the view point control unit 228 substitutes the calculated coefficient “τ” for the equations (6) and (7), and determines the horizontal coordinates (X_{V}, Z_{V}) of the view point (Step S56). Further, the view point control unit 228 determines the eyes direction (Step S57). That is, the view point control unit 228 determines the direction of the view point in the horizontal coordinate system according to the equation (9), and determines the depression angle “τ” according to the equation (10). Then, the view point control unit 228 makes the image generating unit 240 generate the image on the basis of the horizontal coordinates (XV, ZV) and the eyes direction (the direction of the view point and the depression angle “τ” in the horizontal coordinate system), which are calculated, and the view angle “ω_{O}” and the height “Y_{V}” of the view point, which are previously determined (Step S58). When the view point control unit 228 finishes the above-described processing, the view point control unit 228 ends the view point control processing.

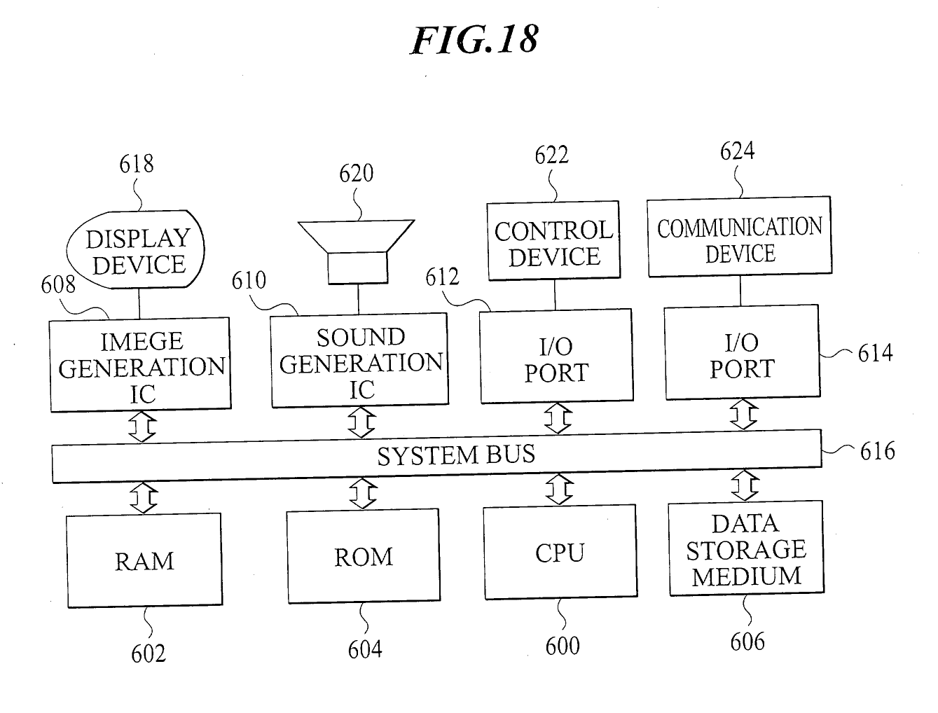

Next, a hardware structure of the game apparatus 1 according to the present embodiment, will be explained with reference to FIG. 18, as follows.

FIG. 18 is a diagram showing an example of the hardware structure realizable of the present embodiment. The game apparatus 1 as shown in FIG. 18 comprises a CPU 600, a RAM 602, a ROM 604, a data storage medium 606, an image generation IC 608, a sound generation IC 610, and I/O ports 612 and 614, that are interconnected by a system bus 616 so that data can be exchanged therebetween. A display device 618 is further connected to the image generation IC 608, a speaker 620 is further connected to the sound generation IC 610, a control device 622 is further connected to the I/O port 612, and a communication device 624 is further connected to the I/O port 614.

The ROM 604 stores initialization information of the game apparatus 1 body, basic information for making each unit of the game apparatus 1, or the like, therein.

The data storage medium 606 corresponds to the storage medium 400 of the functional block as shown in FIG. 7. The data storage medium 606 primarily stores the game program 420, image data for representing each character, the court or the like, of the basket ball game, sound data, play data or the like, therein. For example, in case the present invention is applied to the consumer game machine shown in FIG. 1, the CD-ROM, a game cassette, the DVD, a memory card or other medium is used as the data storage medium 606 for storing the game program 420 or other data. Further, in case the present invention is applied to an arcade game machine, a hardware such as the ROM or other medium is used as the data storage medium 606. In the case, the data storage medium 606 is realized by the ROM 604. Furthermore, in case the present invention is realized by a personal computer, a memory such as the CD-ROM, the DVD, the ROM or the like, a hard disc or other medium is used as the data storage medium 606.

The control device 622 is equivalent to the game controller 3 or 4 shown in FIG. 1. Therefore, the control device 1022 is used so that a player inputs results of decisions according to the game progress to the apparatus body.

The CPU 600 controls the whole apparatus and performs various data processing, according to programs stored in the data storage medium 606, the system program including the initialization information for the apparatus stored in the ROM 604, signals outputted from the control device 622, or the like.

The RAM 602 is storage means used as a work area or the like, for the CPU 600. Further, the RAM 602 stores given contents of the data storage medium 606 or the ROM 604, or results of the operation performed by the CPU 600, therein. The RAM 602 functions so as to correspond to the temporary storage unit 500 of the functional block shown in FIG. 7.

The sound generation IC 610 and the image generation IC 608 are also disposed in such a type of game apparatus, to generate and output game sounds and game images appropriate to the game. The sound generation IC 610 is an integrated circuit for generating game sounds such as sound effects, background music or the like, on the basis of data stored in the data storage medium 606 or the ROM 604. The game sounds generated by the sound generation IC 610 are outputted from the speaker 620. The image generation IC 608 is an integrated circuit for generating pixel data to be outputted to the display device 618, on the basis of image data outputted from the RAM 602, the ROM 604, the data storage medium 606 or the like.

The display device 618 can be realized by a CRT, a LCD, a TV, a plasma display, a projector or the like.

The communication device 624 is a device for communicating various data used by the game apparatus 100 with an external device. When the game apparatus 1 is connected with another game apparatus, the communication device 624 is used for communicating predetermined data corresponding to the game program 420, the game program 420 or other data with another game apparatus, through the communications line.

Various processing explained with reference to FIGS. 1 to 17, is performed by the data storage medium 606 which stores programs including the program for performing the processing while playing the game, shown in the flow charts of FIGS. 9, 13 and 17, the processing when replays the game, or the like, the CPU 600, the image generation IC 608, the sound generation IC 610 or the like, which functions according to the programs. The processing performed by the image generation IC 608, the sound generation IC 610 or the like, may be performed by the CPU 600, a general DSP or the like, as a software.

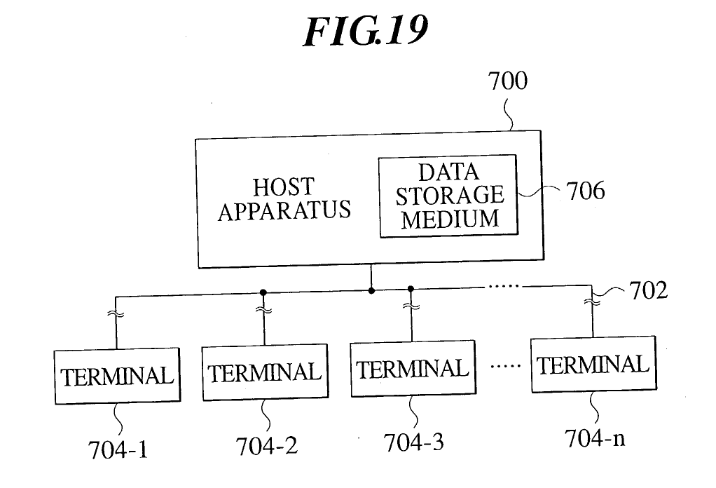

The present invention may be applied to not only the consumer game apparatus 1 shown in FIG. 1, but also any type of game apparatus. For example, FIG. 19 shows an exemplary case the present invention is applied to a game system comprising a host apparatus 700 and terminals 704-1 to 704-n connected to the host apparatus 700 through a communication line 702.

In case of the game system shown in FIG. 19, the game program 420 or the like, stored in the storage unit 400 shown in FIG. 7, is stored in a data storage medium 706, for example, such as a magnetic disk device, a magnetic tape device, a memory or other medium, which can be controlled by the host apparatus 700. In case each of the terminals 704-1 to 704-n comprises the CPU, the image generation IC, and the sound generation IC, and can generate game images and game sounds with standing alone, the host apparatus 700 distributes the game program 420 or the like for generating the game images and the game sounds, to the terminals 704-1 to 704-n. On the other hand, in case each of the terminals 704-1 to 704-n cannot generate game images and game sounds with standing alone, the host apparatus 700 generates game images and game sounds, and distributes them to the terminals 704-1 to 704-n. Therefore, each terminal outputs the game images and the game sounds.

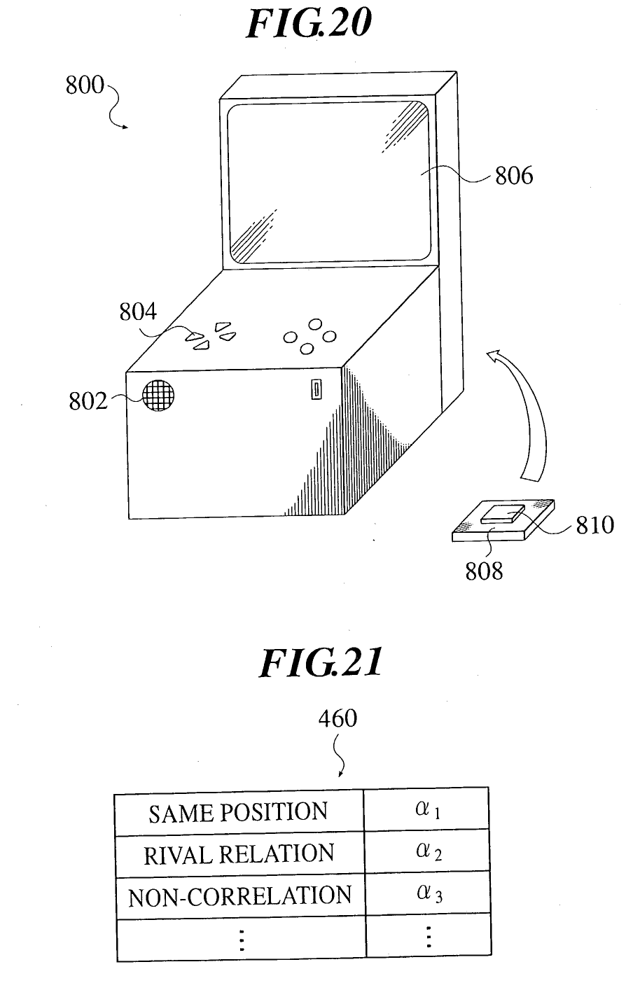

Further, FIG. 20 shows an exemplary case the present invention is applied to an arcade game machine 800. The arcade game machine 800 is an apparatus so that a player enjoys playing a given game by controlling operation buttons 804 and operating a given character displayed on a display 806, with listening sounds outputted from a speaker 802. The CPU 100, the image generation IC, the sound generation IC, the RAM, the ROM, a memory 810 as the data storage medium which stores game information, and so on, are mounted on a system board 808 contained in the arcade game machine 800. Therefore, when the CPU performs various processing explained with reference to FIGS. 9, 13, 17 and so on, and realizes the game.

Next, some exemplary modified embodiments will be explained, as follows.

(1) Exemplary Modified Method for Changing the Movement Ability

According to the above-described embodiment, it has been explained that the movement ability of all the ball possessing character is changed on the same condition. For example, a change rate of a movement ability of a character “F” when the character “F” possess a ball and the positional conditions are satisfied, is the same as one of a character “G” when the character “G” possess a ball and the positional conditions are satisfied. That is, the proper value to the ball possessing character is multiplied by the change coefficient “η” calculated according to the function (3), regardless of the character. However, it is unnecessary to limit to the method. Hereinafter, exemplary modifications will be explained.

[1] Example of a Case the Quantity of Change in the Movement Ability Differs for Every Character

According to the above-described embodiment, the proper value to the ball possessing character which satisfies the positional conditions is multiplied by the change coefficient “η” based on the function (3). However, the quantity of change in the movement ability may be determined so as to differ according to the ball possessing character.

For example, in case the change coefficient “η” is defined by the function of the variable “n” as shown in the function (3), the constant “α” included in the function may be determined as the proper value to the character. That is, the value of the change coefficient “η” obtained according to the different coefficient “α”, even if the value of “n” is the same, may be determined so as to differ for every character.

More specifically, the proper “α” is determined for each character, such as a proper “α_{F}” to the character “F”, a proper “α_{G}” to the character “G” or the like. Herein, the constant “α” satisfies “0<α<1”. While executing the game, the processing system (for example, the ability change unit 224) of the game apparatus 1 reads the value of the exponent “α” corresponding to the ball possessing character, substitutes it for the function (3), and calculates the change coefficient “η”. Therefore, because the quantity of change in the movement ability is determined so as to differ according to the ball possessing character, it is possible to produce a character capable of keeping a presence of mind, a character disturbed to be marked by the opponent character, or the like.

[2] Example of a Case the Quantity of Change in the Movement Ability Differs According to the Opponent Character

According to the above-described embodiment, the proper value to the ball possessing character is multiplied by the change coefficient “η” based on the function (3), regardless of the type of the opponent character which satisfies the positional conditions. However, the quantity of change in the movement ability of the ball possessing character may be determined so as to differ according to the opponent character whish satisfies the positional conditions.

For example, the constant “α” is determined for every character, such as a constant “α_{F}” for the character “F”, a constant “α_{G}” for the character “G”, a constant “α_{H}” for the character “H”, or the like. Herein, the constant “α” satisfies “0<α”. The processing system of the game apparatus 1 calculates the change coefficient “η” for the ball possessing character, according to the following function (11), when the character F satisfies the positional conditions.

η=exp{−α_{F}} (11)

Further, the processing system calculates the change coefficient “η”, according to the following function (12), when the characters F and G satisfy the positional conditions.

η=exp{−(α_{F}+α_{G})} (12)

As described above, because the quantity of change in the movement ability of the ball possessing character is determined according to the type of the opponent character, it is possible to express whether the ball possessing character is good at or bad at the defense.

[3] Example of a Case the Quantity of Change in the Movement Ability Differs According to the Congeniality

The quantity of change in the movement ability of the ball possessing character may be changed according to the correlation (or the congeniality) between the opponent character which satisfies the positional conditions and the ball possessing character. For example, in case characters in opposed positions are closed to each other, in case characters having a rival relation are closed to each other, or the like, the quantity of change in the movement ability of the ball possessing character is determined to be large. On the other hand, in case characters having a little non-correlation are closed to each other, the quantity of change in the movement ability of the ball possessing character is determined to be small.

More specifically, for example, the change coefficient “η” is-calculated according to the following function (13).

η=exp{−α} (13)

The processing system of the game apparatus 1 substitutes the exponent based on the correlation between the opponent character which satisfies the positional conditions and the ball possessing character, for “α” included in the function (13), while executing the game.

FIG. 21 is a table showing an example of a correlative table 460 relating the correlation and the exponent. As shown in FIG. 21, the correlative table 460 relates the case the ball possessing character and the opponent character which satisfies the positional conditions are in the same positions as each other to the exponent “α₁”, the case the ball possessing character and the opponent character have the rival relation to the exponent “α₂”, and the case the ball possessing character and the opponent character have the non-correlation to the “α₃”, and stores the relations therein.

The processing system (for example, the positional condition determination unit 222) of the game apparatus 1 stores not only coordinate data or the ball possession of each character, but also the codes for distinguishing the positions, the rival characters or the like, from each other, in the ability data 520. Further, the processing system (for example, the ability change unit 224) of the game apparatus 1 determines the position or the rival relation of the opponent character which satisfies the positional condition. Then, the processing system reads the exponent corresponding to the result of the determination out of the correlation table 460 shown in FIG. 21, and calculates the change coefficient “η”.

In case there are a plurality of opponent characters which satisfy the positional conditions , the processing system may add the exponents corresponding to the opponent characters, and determine the change coefficient “η”, according to the following function (14).

η=exp{−(α₁+α₂+α₃+. . . )} (14)

As described above, because the correlation between the characters, is expressed, it is possible to work out the plan of the basket ball game, carefully.

[4] Example of a Case the Quantity of Change in the Movement Ability Differs According to the Type of the Movement

According to the above-described embodiment, it has been explained that the movement ability is changed by multiplying the proper value by the change coefficient “η” (or the reciprocal number (1/η)), regardless of the type of the movement. However, it is unnecessary to limit to the method. It is needless to say that the rate of change in the movement ability may be changed according to the type of the movement.

For example, in case of defining the change coefficient “η” by the function (3) having the variable “n”, the processing system substitutes the value corresponding to the type of the movement for “α” (0<α<1) included in the function (3). For example, in order to make the ball possessing character jump, the processing system substitutes “α_{J}” for “α” included in the function (3). Further, in order to make the ball possessing character dribble the ball, the processing system substitutes “α_{D}” for “α” included in the function (3). Further, in order to make the ball possessing character pass the ball, the processing system substitutes “α_{S}” for “α” included in the function (3). Further, in order to make the ball possessing character shoot the ball, the processing system substitutes “α_{S}” for “α” included in the function (3). Therefore, because the value of “α” corresponding to the type of the movement is determined and substituted for the function (3), it is possible to express the change in the movement ability for every movement.

[5] Example of a Case the Quantity of Change in the Movement Ability Differs According to the Distance Between the Characters

According to the above-described embodiment, it has been explained that the movement ability of the ball possessing character is changed according to the number of opponent characters which satisfy the positional conditions. However, the quantity of change in the movement ability may be changed according to the shortest distance “r_{MIN}” of the distances between the opponent characters and the ball possessing character.

More specifically, in case there is not any opponent character which satisfies the positional conditions, the processing system determines the change coefficient “η” to be “1” (η=1). On the other hand, in case there are opponent characters which satisfy the positional conditions, the processing system selects the shortest distance “r_{MIN}” of distances between the opponent characters and the ball possessing character, and determines the change coefficient “η” according to the following function (15).

η=exp{−α/r_{MINI}} (15)

Therefore, because the movement ability is changed according to the distance “r_{MIN}” between the opponent character which satisfies the positional conditions and the ball possessing character, it is possible to express the movement of the mind of the ball possessing character, more realistically.

[6] Example of a Case the Quantity of Change in the Movement Ability Differs According to the Difference Between the Game Scores

According to the above-described embodiment, it has been explained that the movement ability of the ball possessing character is changed according to the number of opponent characters which satisfy the positional conditions. However, the movement ability may be changed according to the difference between the game scores.

For example, in case the team to which the ball possessing character belongs is defeated for the opponent team, the movement ability of the ball possessing character may fall. On the other hand, in case the team defeats the opponent team, the movement ability may be improved on the proper ability. More specifically, for example, in case the ball possessing character belongs to the team A, and the team A fights with the team B, when the score of the team A is “α”, and the score of the team B is “b”, the processing system of the game apparatus 1 determines the change coefficient “η” according to the following function (16).

η=exp{−αn+(1−b/a)} (16)

In case the scores “a” and “b” are “0”, the processing system substitutes “1” for each of “a” and “b”. According to the function (16), because “exp{1−b/a}” is larger than “1” (exp{1−b/a}>1) when “a” is larger than “b” (a>b), the movement ability of the ball possessing character is improved. On the other hand, because “exp{1−b/a}” is smaller than “1” (exp{1−b/a}<1) when “a” is smaller than “b” (a<b), the movement ability of the ball possessing character falls.

Further, in case the team to which the ball possessing character belongs is defeated for the opponent team, the movement ability of the ball possessing character may be improved, in order to cover the difference between the scores. On the other hand, in case the team defeats the opponent team, the movement ability may fall.

[7] Example of a Case the Quantity of Change in the Movement Ability Differs According to the Rest Time of the Game

According to the above-described embodiment, it has been explained that the movement ability of the ball possessing character is changed according to the number of opponent characters which satisfy the positional conditions. However, the movement ability may be changed according to the rest time of the game.

For example, in case the limited time of the game is “T”, and the passage time “t” is equal to or larger than “0” and equal to or smaller than “T/2” (0≦t≦T/2), the processing system calculates the change coefficient “η” according to the function (3). On the other hand, in case the passage time “t” is larger than “T/2” and equal to or smaller than “T” (T/2≦t≦T), the processing system calculates the change coefficient “η” according to the following function (17).

η=I exp{−αn} (17)

Herein, “I” is a constant which satisfies “0<I<1”.

According to the function (17), because the constant “I” causes the change coefficient “η” to be always smaller than “1”, the movement ability falls. Therefore, because the movement ability is changed as the time passes, it is possible to produce the tiredness, the decline of the decision or the like, of the character.

[8] Example of a Case the Quantity of Change in the Movement Ability Differs According to the Passage Time the Positional Conditions are Satisfied

According to the above-described embodiment, it has been explained that the movement ability of the ball possessing character is changed according to the number of opponent characters which satisfy the positional conditions. However, the movement ability of the ball possessing character may be changed according to the passage time the positional conditions are satisfied.

For example, the change coefficient “η” is defined according to the following function (18) or (19).

η=exp{−φt} (18) or

η=J−exp{−φt} (19)

Herein, “φ” is a positive constant, “J” is a positive constant which is larger than “1” (J>1), and “t” indicates the passage time the opponent character satisfies the positional conditions. According to the function (18), because the change coefficient “η” becomes smaller with the passage of time, it is possible to produce the movement ability which changes from usually, gradually. On the other hand, according to the function (19), the change coefficient “η” approaches the value of “J” with the passage of time. Accordingly, if “J” is approximately “1” (J≈1), it is possible to produce the movement ability of the ball possessing character, which changes back to usually, gradually, with the passage of time. Further, the quantity of change in the movement ability may be determined so as to differ whether the team to which the ball possessing character belongs is a home team or an away team.

Further, according to the above-described explanation, the movement ability may be changed by multiplying the proper value for determining the movement ability by the change coefficient “η”. However, it is unnecessary to limit to the method. For example, it is needless to say that the movement ability is directly determined by using data in the table format relating the movement ability (for example, the proper value) to the condition (for example, the number of opponent characters which satisfy the positional conditions, the distance between the opponent character and the ball possessing character, or the like), or the like.

Further, the case has been explained as an example, that the exponential function is used as the function for defining the change coefficient “η”. However, it is unnecessary to limit to the case. It is needless to say that the change coefficient “η” may be calculated according to a linear function.

Further, according to the above-described explanation, the case has been explained mainly, that the movement ability of the ball possessing character falls according as there is any opponent character which satisfies the positional conditions, or not. However, it is needless to say that the movement ability may be improved according as there is any opponent character which satisfies the positional conditions, or not.

(2) Exemplary Modified Method for Controlling the View Point

According to the above-described embodiment, in case the operated character possesses the ball, it has been explained that the position of the view point is approached to the operated character, according to the distance between the opponent character which satisfies the positional conditions and the ball possessing character. However, it is unnecessary to limit to the above-described method. It is no problem to adopt any method for changing the field of vision in the virtual space, when any opponent character satisfies the positional conditions.

[1] Example of Changing the View Angle

According to the above-described embodiment, usually, the processing system of the game apparatus 1 determines the position of the view point in the horizontal coordinate system, according to the equations (4) and (5). When the conditions “a” and “b” are satisfied, that is, when the operated character possesses the ball, and there is any opponent character which satisfies the positional conditions, the processing system changes the values of the constants (X_{O}, Z_{O}) included in the equations (4) and (5) and approaches the view point to the operated character. However, the processing system may change the view angle “ω” without changing the values of the constants (X_{O}, Z_{O}). The view angle is an angle of the view point to adjacent vertexes of a view window (rectangle). Therefore, the view angle in the horizontal direction, and the view angle in the vertical direction are different from each other.

In case of performing the perspective projection on the view point, and generating the image, when the view window is provided for the projection surface, and the size of the view window is constant, the change of the view angle is equivalent to the change of the distance between the view point and the projection surface (that is, the view window). That is, the view angle becomes small, as the projection surface is far away from the view point. On the other hand, the view angle becomes large, as the projection surface is approached to the view angle. Therefore, a method for changing the position (that is, the depth) of the view point on the basis of the position of the projection surface in the virtual space, or a method for changing the position (that is, the depth) of the projection surface on the basis of the position of the view point, will be thought as the method for changing the view angle. Hereinafter, the latter, that is, the method for changing the position of the projection surface, will be explained.

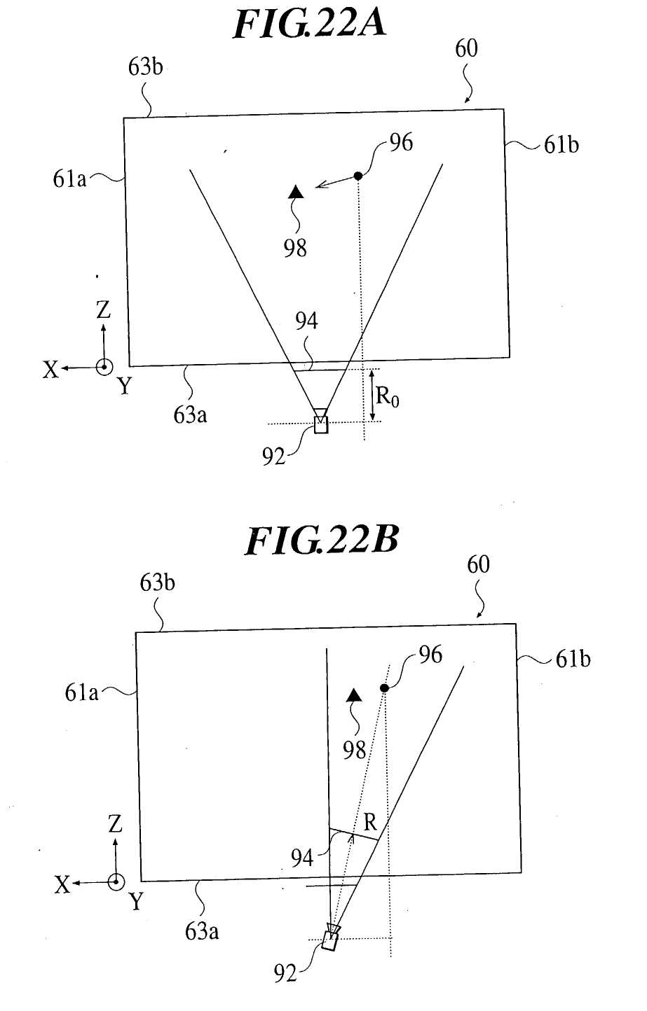

FIGS. 22A and 22B are views for explaining an example of changing the view angle.

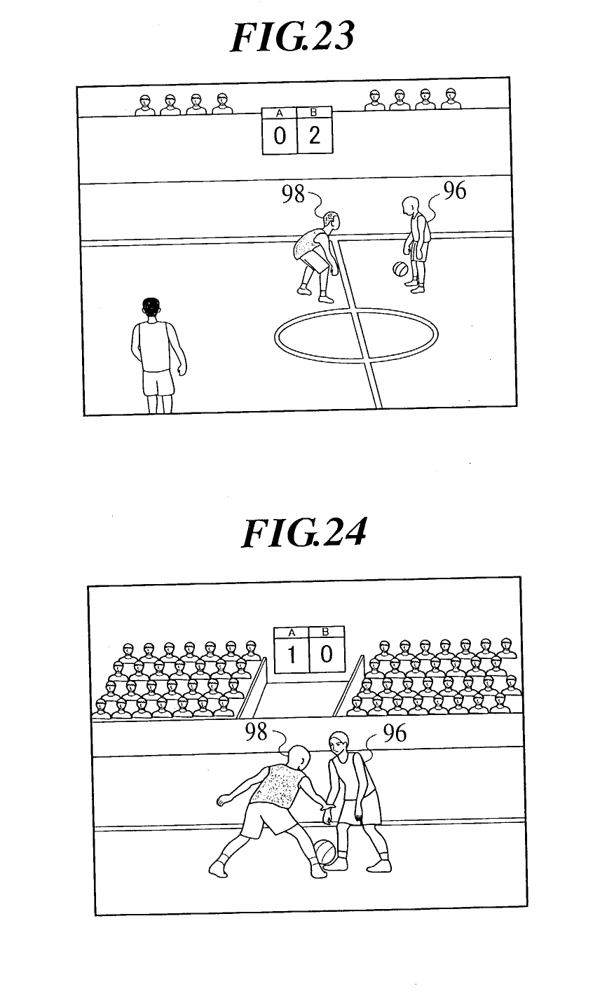

FIG. 22A is a view showing the usual positional relation between a view point 92 and a projection surface 94. That is, the view shows the positional relation when the operated character does not possess the ball, or the operated character possesses the ball and there is not any opponent character which satisfies the positional conditions. In FIG. 22A, a black circle sign 96 shows the operated character, and a black triangle sign 98 shows the opponent character. Further, in FIG. 22A, in order to simplify the figure, only the end lines 61a and 61b and the side lines 63a and 63b are shown in the court 60, and other lines are omitted to be shown in the court 60. Usually, the eyes direction of the view point 92 is parallel to the Z axis, and the distance “R” between the view point 92 and the projection surface 94 is “R_{O}” which is constant, in the horizontal coordinate system. FIG. 23 is an exemplary view of an image generated on the basis of the view point 92 having the positional relation shown in FIG. 22A. As shown in FIG. 23, the comparatively extensive virtual space is displayed.

FIG. 22B is a view showing an example of the direction of the view point and the position of the projection surface, in case the operated character 96 possesses the ball, and the opponent character 98 satisfies the positional conditions. In FIG. 22B, the eyes vector of the view point is turned to the position of the operated character 96, and the distance “R” between the view point 92 and the projection surface 94 is longer than the usual distance “R_{O}”. Therefore, the view angle becomes smaller, and the displayed range of the virtual space becomes smaller. At the same time, the height “Y_{V}” of the view point is lowered. FIG. 24 is an exemplary view of an image generated on the basis of the view point having the positional relation shown in FIG. 22B. As shown in FIG. 24, because the operated character is enlarged and displayed on the screen, and the height “Y_{V}” of the view point is lowered, it is possible to increase presence and tension.

The distance “R” between the view point 92 and the projection screen 94 may be determined according to the distance between the opponent character which satisfies the positional conditions and the operated character. For example, the distance “R” may be determined so that the view point and the projection surface are far away from each other, as the opponent character approaches the operated character. Therefore, the opponent character and the operated character are enlarged more and displayed, as the opponent character approaches the operated character.

[2] Example of Shading the Circumference of the Ball Possessing Character

In order to change the field of vision, the circumference of the object may be shaded. More specifically, in case the operated character possesses the ball, and there is any opponent character which satisfies the positional conditions, the processing system of the game apparatus 1 shades and expresses an area other than the range of the radius “κ” from the center which is the representative point of the operated character. There are various methods for shading the area. For example, the processing system composes a predetermined color (for example, white or black) with the image, gradually, as the image is far from one point (that is, the representative point of the operated character), as known for a fog processing. Therefore, because the circumference of the operated character (that is, the ball possessing character) is shaded, it is possible to express the anxiety of the operated character which cannot see the circumference.

(3) Exemplary Modified Method for Changing the Timing of Determining the Positional Conditions

According to the above-described embodiment, the positional condition determination unit 222 performs the above-described processing for every predetermined time (for example, for every frame) However, it is unnecessary to limit to the timing. The positional condition determination unit 222 may perform the position determination processing on a predetermined opportunity. For example, when the processing system of the game apparatus 1 makes the ball possessing character pass or shoot the ball while executing the game, there is a case the processing system makes the ball possessing character look around the circumference in the virtual space, in order to determine the direction of the ball. Therefore, the positional condition determination unit 222 may perform the position determination processing, after the ball possessing character has looked around the circumference, or while the ball possessing character is looking around the circumference. The ball possessing character may look around the circumference according to the operation inputted by the player, or automatically according to the game program 420.

(4) Exemplary Modified Method for Changing the Expression of the Character

According to the above-described embodiment, when the positional conditions are satisfied, the movement ability of the ball possessing character is changed, or the field of vision at the view point is changed. However, the change of the movement ability may be expressed visually, not only according to the above-described method, but also by changing the expression of the character (a complexion or a behavior). For example, when the positional conditions are satisfied, the processing system of the game apparatus 1 changes the complexion of the ball possessing character into a poor complexion, or the expression of the ball possessing character into a triumphant expression. Further, the processing system makes the ball possessing character scared, confused or look around the circumference restlessly, with the change of the movement ability.

More specifically, when the number “n” is not equal to “0” (n≠0) according to the positional condition determination processing (FIG. 9), that is the positional conditions are satisfied, the processing system (for example, the movement control unit 226) of the game apparatus 1 makes the character scared, or look around the circumference restlessly. Further, when generating the image, the processing system (for example, the image generating unit 240) of the game apparatus 1 changes the basic color of the texture to be mapped on the face portion of the ball possessing character, and the complexion into a pale complexion, or changes the texture to be mapped on the face portion of each character, and provides sweats on the face portion or near the head. Accordingly, the processing system generates the image.

As described above, because the positional conditions are satisfied, and it causes the expression of the ball possessing character to change, it is possible to let the player know the change in the movement ability, visually.

Further, the change in the movement ability may be expressed by not only changing the expression of the character, but also the numeral value or a bar graph, directly.

According to the above-described embodiment, the present invention has been explained according to the basket ball game for example of the ball game. However, it is unnecessary that the present invention is limited to the basket ball game. For example, the present invention can be applied to a soccer game, a hockey game, a handball game, a water polo game, or the like. Further, the value of the parameter for determining the movement ability may be determined and displayed on the screen.

As described above, according to the present invention, the positional relation between the ball possessing character and another character is determined, and in case there is any character which satisfies the positional conditions, the movement ability of the ball possessing character is changed. Consequently, it is possible to express the change in the mind of the ball possessing character, caused by the positional relation between the characters, by changing the movement ability of the ball possessing character.

The entire disclosure of Japanese Patent Application No. Tokugan 2002-017273 filed on Jan. 25, 2002 including specification, claims, drawings and summary are incorporated herein by reference in its entirety.

What is claimed is:

1. A method for moving a predetermined character according to an inputted operation, executing a ball game in which a plurality of characters including the predetermined character appear, and generating an image of a virtual space in which the plurality of characters are provided, on the basis of a view point, the method comprising:
determining whether a positional relation between a ball possessing character which possesses a ball and a second character, of the plurality of characters, satisfies a positional condition, or not; and
changing a movement ability of at least one of the ball possessing character and the second character, when the positional relation satisfies the positional condition.

2. The method as claimed in claim 1, wherein the positional condition includes whether the second character is in a predetermined direction of the ball possessing character, or not.

3. The method as claimed in claim 1, wherein the positional condition includes whether the second character is within a predetermined range following the ball possessing character, or not.

4. The method as claimed in claim 3, wherein the changing a movement ability includes determining a quantity of change in a movement ability of at least one of the ball possessing character and other characters which are within the predetermined range, according to a number of the other characters.

5. The method as claimed in claim 3, wherein the changing a movement ability includes determining a quantity of change in the movement ability, according to a time the second character is within the predetermined range.

6. The method as claimed in claim 1, wherein the changing a movement ability includes determining a quantity of change in the movement ability according to a distance between the ball possessing character and the second character.

7. The method as claimed in claim 1, wherein the changing a movement ability includes changing a movement ability of the ball possessing character.

8. The method as claimed in claim 7, wherein the changing the movement ability includes determining a quantity of change in the movement ability, according as which character of the plurality of characters which appear in the ball game is the second character.

9. The method as claimed in claim 7, wherein the changing the movement ability includes determining a quantity of change in the movement ability, according as which character of the plurality of characters which appear in the ball game is the ball possessing character.

10. The method as claimed in claim 7, wherein the changing the movement ability includes determining a quantity of change in the movement ability, according as what combination of characters of the plurality of characters which appear in the ball game is a combination of the ball possessing character and the second character.

11. The method as claimed in claim 10, wherein the changing the movement ability includes determining a quantity of change in the movement ability, according to a combination of a position of the ball possessing character and a position of the second character.

12. The method as claimed in claim 7, wherein the changing the movement ability includes changing the movement ability only when the second character belongs to an opponent team of the ball possessing character, in the ball game.

13. The method as claimed in claim 7, wherein the changing the movement ability includes changing the movement ability for at least one of a shot, a pass, a jump and a dribble, of the ball possessing character.

14. The method as claimed in claim 1, further comprising: making the ball possessing character look over a circumference of the ball possessing character,
wherein the determining whether a positional relation between a ball possessing character which possesses a ball and a second character, of the plurality of characters, satisfies a positional condition, or not, includes determining whether the positional relation satisfies the positional condition or not, when the ball possessing character looks over the circumference.

15. The method as claimed in claim 1, wherein the changing a movement ability includes determining a quantity of change in the movement ability according to any one of a rest time and a score difference of the ball game.

16. The method as claimed in claim 1, further comprising: changing an expression of the ball possessing character, when the positional relation satisfies the positional condition.

17. The method as claimed in claim 1, further comprising: changing a range to be displayed, of the image of the virtual space on the basis of the view point.

18. The method as claimed in claim 17, wherein the changing a range includes determining a quantity of change in the range to be displayed, on the basis of at least one of a distance between the ball possessing character and the second character, a number of other characters each of which has the positional relation which satisfies the positional condition, and a passage time the positional relation satisfies the positional condition.

19. The method as claimed in claim 17, wherein the changing a range includes changing the range to be displayed, by performing at least one of a processing for changing a distance of the view point to the ball possessing character, a processing for changing a view angle of the view point, and a processing for shading a circumference of the ball possessing character.

20. A method comprising:
determining whether a positional relation between at least two characters of a plurality of characters which appear in a game, satisfies a positional condition, or not; and
changing a movement ability of at least one of the at least two characters, when the positional relation satisfies the positional condition.

21. An apparatus for moving a predetermined character according to an inputted operation, generating and displaying an image of a virtual space in which a plurality of characters including the predetermined character are provided, on the basis of a view point, and executing a ball game in which the plurality of characters appear, the apparatus comprising:
a position determining section for determining whether a positional relation between a ball possessing character which possesses a ball and a second character, of the plurality of characters, satisfies a positional condition, or not; and
a movement ability changing section for changing a movement ability of at least one of the ball possessing character and the second character, when the positional relation satisfies the positional condition.

22. A storage medium having information recorded thereon, when the information is loaded onto an operating apparatus, the information making the operating apparatus execute the method as claimed in any one of claims 1 to 19.

23. A data signal embodied in a carrier wave, comprising information used for executing the method as claimed in any one of claims 1 to 19.

24. A program, when the program is loaded onto an operating apparatus, the program making the operating apparatus execute the method as claimed in any one of claims 1 to 19.
